(19) United States
(12) Patent Application Publication
(10) Pub. No.: US 2011/0043808 A1
(43) Pub. Date: Feb. 24, 2011

(54) MEASURING APPARATUS

(76) Inventors: Hisashi ISOZAKI, Itabashi-ku (JP); Yoshiyuki Enomoto, Itabashi-ku (JP)

Correspondence Address: WENDEROTH, LIND & PONACK, L.L.P., 1030 15th Street, N.W.,, Suite 400 East, Washington, DC, 20005-1503, US

(21) Appl. No.: 12/857,879

(22) Filed: Aug. 17, 2010

(30) Foreign Application Priority Data
Aug. 18, 2009 (JP) 2009-189437

(51) Int. Cl. G01N 21/55

(52) U.S. Cl. 356/445

(57) ABSTRACT

A measuring apparatus for measuring a surface shape of a target, includes a projection system to radiate a line beam on the target, an imaging device to acquire a reflected line beam reflected from the target, a plurality of imaging systems each configured to cause the reflected line beam to form an image on a receiving surface of the imaging device so that a shape of the line beam on the target is acquired and a splitting mechanism to split the reflected line beam and guide the split reflected line beam to the imaging device. The imaging systems have different optical settings for the object in the target, a plurality of segments are set on the receiving surface while each of the segments in each of which at least one region is set as a reception region is partitioned into a plurality of regions, and the imaging system causes the reflected line beams split by the splitting mechanism to form images on the reception regions in the different segments, respectively.

### CROSS REFERENCE TO RELATED APPLICATIONS

The present application is based on and claims priority from Japanese Application Number 2009-189437, filed on Aug. 18, 2009, the disclosure of which is hereby incorporated by reference herein in its entirety.

### BACKGROUND OF THE INVENTION

1. Field of the Invention

The present invention relates to a measuring apparatus for measuring a measurement target, and particularly relates to a measuring apparatus for measuring a measurement target by use of a light beam.

2. Description of the Related Art

Some wafers, for example, are known to be provided with ball-shaped terminals (referred to below as bumps) formed by soldering or the like to provide wiring for each electronic component. As one of inspections for the electronic components, such wafers before dicing are inspected by measuring the height of each bump. To measure the height of a bump, the following type of Measuring apparatus has been employed (see JP-A 2000-266523, for example). Specifically, in this apparatus, a wafer as a measurement target is irradiated with a laser beam or the like (referred to below as a line beam), an image of the part irradiated with the line beam is picked up by an imaging device, and the heights in certain parts of the wafer, that is, the heights of the bumps and the like are measured by use of the image data. In this measuring apparatus, an optical imaging system is provided between the imaging device and the measurement target. The optical imaging system is set so that the imaging device is capable of picking up an image of the part irradiated with the line beam.

From the viewpoint of manufacturing efficiency of a measurement target (a wafer in the above example), in the measurement of the measurement target, it is required to make time required for measuring (referred to below as measuring time) as short as possible while maintaining a certain accuracy. For this reason, in the above-mentioned optical imaging system, an optical setting is determined for an object for measurement (each bump in the example above) in the measurement target to make the measuring time as short as possible while maintaining certain accuracy.

However, in the apparatus described above, only the measurement data according to optical settings for the object for measurement in the measurement target is obtained.

### SUMMARY OF THE INVENTION

The present invention has been made in view of the above circumstances, and aims to provide a measuring apparatus capable of obtaining a plurality of measurement data in different optical settings for the object for measurement in the measurement target without increasing time required for measurement.

A measuring apparatus according to an example of the present invention includes: a projection optical system configured to radiate a line beam on a measurement target; and an imaging device configured to acquire a reflected line beam reflected from the measurement target, the measuring apparatus measuring a surface shape of the measurement target on the basis of a geometric positional relationship in the reflected line beam on the measurement target, the reflected line beam being acquired by the imaging device. The measuring apparatus further includes a plurality of optical imaging systems each provided between the measurement target and the imaging device, and each configured to cause the reflected line beam to form an image on a receiving surface of the imaging device so that a shape of the line beam on the measurement target is acquired; and a beam splitting mechanism provided between the measurement target and each of the plurality of optical imaging systems, and configured to split the reflected line beam and guide the split reflected line beam to the imaging device. The optical imaging systems have different optical settings for the object in the measurement target from each other, a plurality of segments are set on the receiving surface of the imaging device while each of the segments is partitioned into a plurality of regions, and at least one region in each of the segments is set as a reception region; and the optical imaging system causes the reflected line beams split by the beam splitting mechanism to form images on the reception regions in the different segments, respectively, on the receiving surface of the imaging device.

### BRIEF DESCRIPTION OF THE DRAWINGS

FIG. 1 is a block diagram showing a configuration of a measuring apparatus 10 according to an embodiment of the present invention.

FIG. 2 is an explanatory view schematically showing a relationship between a measurement target (wafer 16) and an optical system 11 in the measuring apparatus 10.

FIG. 3 is a schematic explanatory view for explaining a slide movement of the measurement target (wafer 16) on a stage 12 in the measuring apparatus 10.

FIG. 4 is an explanatory view schematically showing a relationship between a line beam L and an object for measurement in the measurement target (wafer 16), to explain measurement by the measuring apparatus 10.

FIGS. 5A to 5E are explanatory views each schematically showing a state where an acquired measurement result is displayed on a display 14 as a visualized diagram. FIG. 5A corresponds to a line beam L1 of FIG. 4; FIG. 5B corresponds to a line beam L2 of FIG. 4; FIG. 5C corresponds to a line beam L3 of FIG. 4; FIG. 5D corresponds to a line beam L4 of FIG. 4; and FIG. 5E corresponds to a line beam L5 of FIG. 4.

FIG. 6 is an explanatory view for explaining a configuration of an imaging device 17.

FIG. 7 is a configuration diagram schematically showing a reception optical system 361 in an optical system 111 according to a first embodiment.

FIG. 8 is an explanatory view schematically showing a state of an object of measurement (bumps 19c and 19d) on the measurement target (wafer 16), to describe measurement by the measuring apparatus 101.

FIGS. 9A to 9C are explanatory views each schematically showing a state where measured data measured from the object of measurement (bumps 19 c and 19d) shown in FIG. 8 is displayed on a display 14 as a visualized diagram. FIG. 9A shows measured data acquired from a side corresponding to a first optical path w1; FIG. 9B shows measured data acquired from a side corresponding to a second optical path w2; and FIG. 9C shows a state where the pieces of measured data shown in FIGS. 9A and 9B are combined.

FIG. 10 is a view schematically showing a reception optical system 362 in an optical system 112 according to a second embodiment.

FIG. 11 is an explanatory view schematically showing a relationship between a measurement target (wafer 16) and an optical system 113 in a measuring apparatus 103 according to a third embodiment.

FIG. 12 is a view schematically showing a reception optical system 363 in the optical system 113.

FIG. 13 is an explanatory view schematically showing a filter 52 provided in the imaging device 17.

FIG. 14 is a view schematically showing a reception optical system 364 in an optical system 114.

FIG. 15 is an explanatory view schematically showing a state where a first imaging optical system 33′ and a second imaging optical system 34′ have different resolution for a measurement target.

### DETAILED DESCRIPTION OF THE PREFERRED EMBODIMENTS

Hereinafter, embodiments of a measuring apparatus according to an example of the present invention will be described with reference to the drawings.

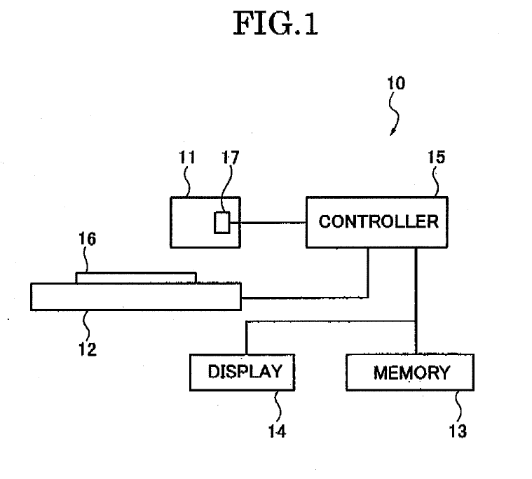

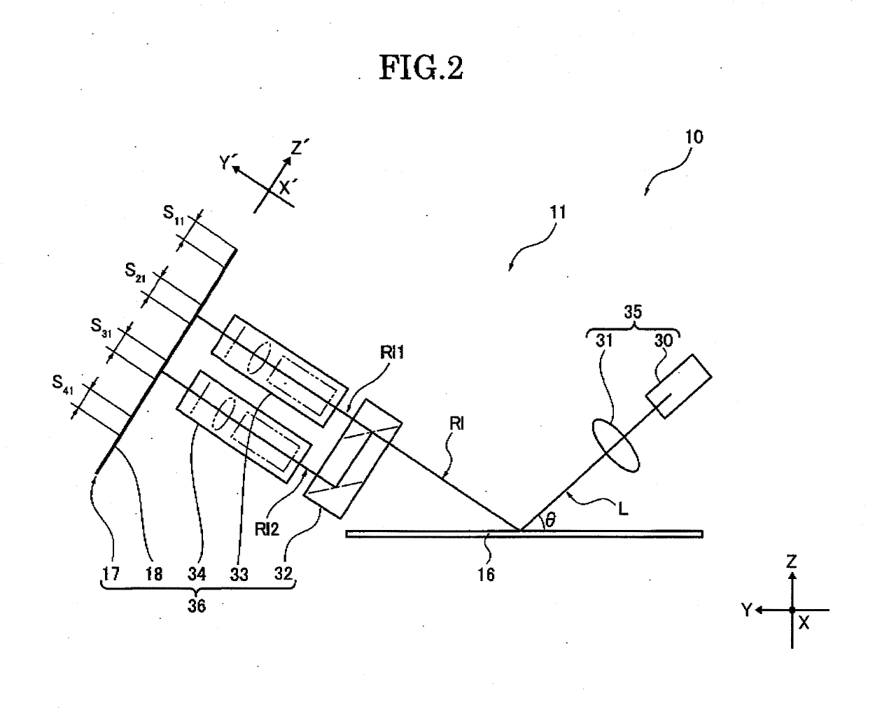

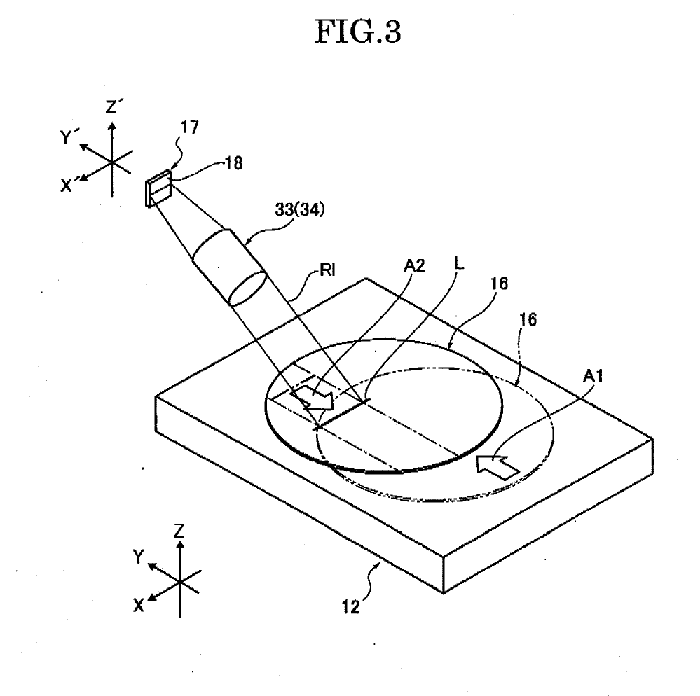

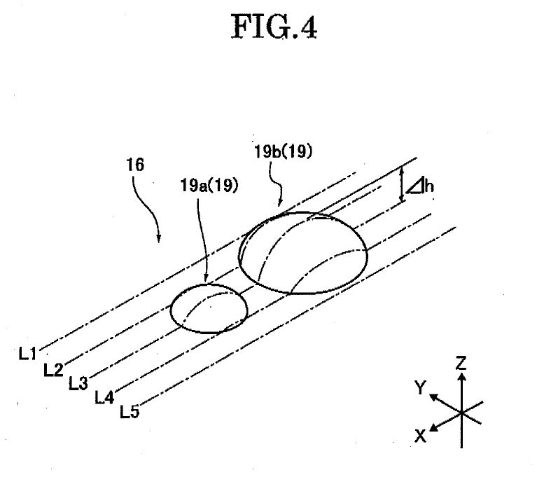

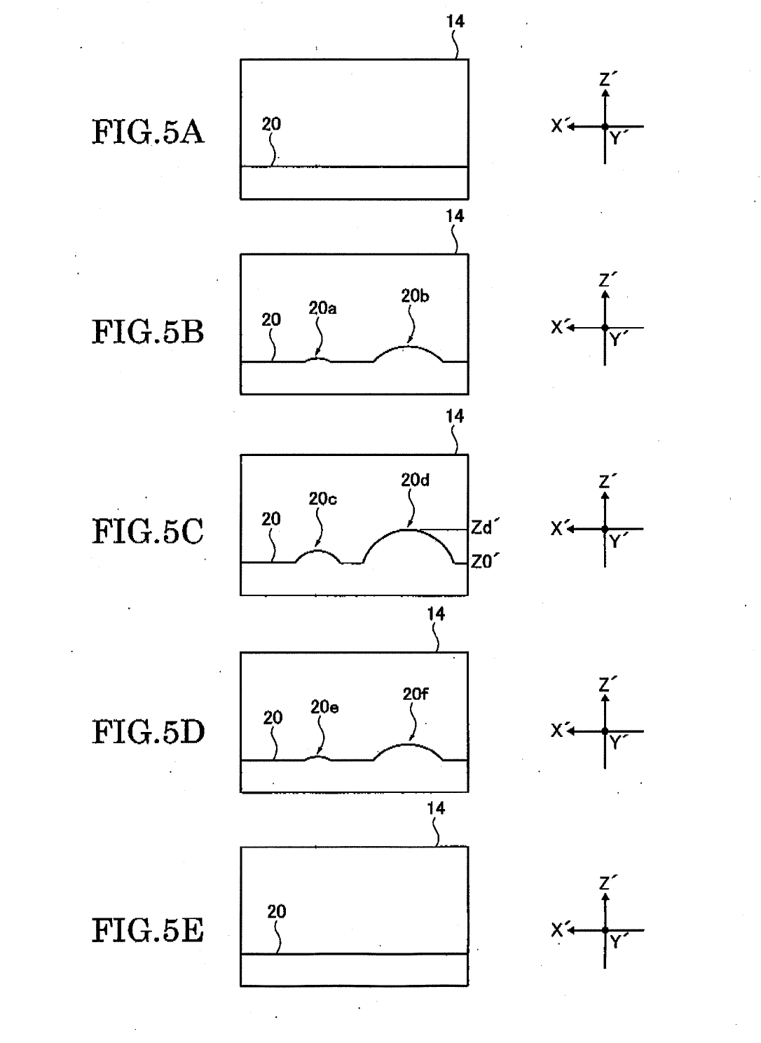

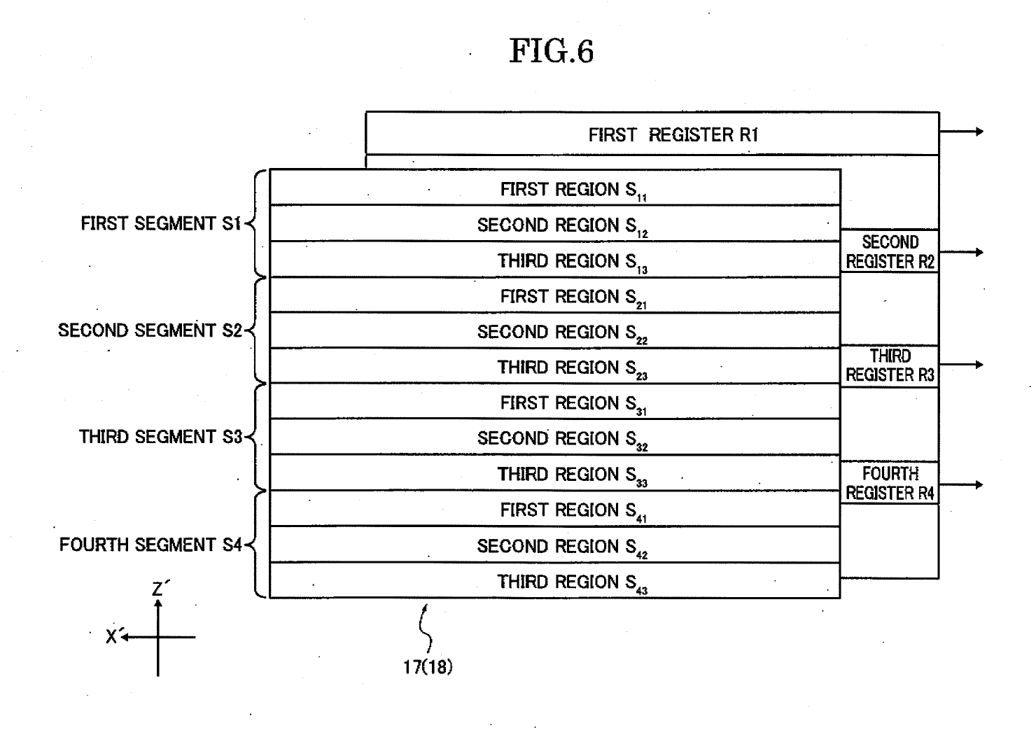

Firstly, the concept of the measuring apparatus according to the example of the present invention will be described. FIG. 1 is a block diagram showing a configuration of a measuring apparatus 10 according to the example of the present invention. FIG. 2 is an explanatory view schematically showing a relationship between a measurement target (wafer 16) and an optical system 11 in the measuring apparatus 10. FIG. 3 is a schematic explanatory view for explaining a slide movement of the measurement target (wafer 16) on a stage 12 in the measuring apparatus 10. FIG. 4 is an explanatory view schematically showing a relationship between the line beam L and the object for measurement in the measurement target (wafer 16), to explain measurement by the measuring apparatus 10. FIGS. 5A to 5E are explanatory views each schematically showing a state where an acquired measurement result is displayed on a display 14 as a visualized diagram. FIG. 5A corresponds to a line beam L1 of FIG. 4; FIG. 5B corresponds to a line beam L2 of FIG. 4; FIG. 5C corresponds to a line beam L3 of FIG. 4; FIG. 5D corresponds to a line beam L4 of FIG. 4; and FIG. 5E corresponds to a line beam L5 of FIG. 4. FIG. 6 is an explanatory view for explaining a configuration of an imaging device 17. Note that in the drawings and in the following description, a mount surface of a stage 12 is denoted by an X-Y plane, a direction intersecting the X-Y plane is denoted by a direction Z, and a direction in which the measurement target (wafer 16) mounted on the stage 12 is slid is denoted by a direction. Y. In addition, on a receiving surface 18 of the imaging device 17, directions corresponding to the directions X and Z on the stage 12 are denoted by directions X′ and Z′, respectively, and a direction intersecting an X′-Z′ plane is denoted by a direction Y′.

The measuring apparatus 10 according to the example of the present invention carries out a measuring method employing an optical lever scheme in which a single line beam is radiated. As the basic concept, the measuring apparatus 10 aims to simultaneously acquire multiple pieces of measured information (measured data) without elongating the measuring time. In the apparatus, a projection optical system radiates a line beam on a measurement target, an imaging device of a reception optical system acquires a reflected line beam reflected from the measurement target, and the surface shape of the measurement target is measured on the basis of the geometric positional relationship in the reflected line beam on the measurement target. The reception optical system employs an imaging device whose receiving surface is set to have multiple segments. To acquire the shape of the line beam on the measurement target, the reflected line beam is split, and the split reflected line beams are caused to form images on different segments on the receiving surface of the imaging device. To be more specific, by using the measuring apparatus 10, multiple pieces of measured information (measured data) whose optical settings for the object of measurement in the measurement target differ from one another can be acquired simultaneously without increasing time required for the measurement. As shown in FIG. 1, the measuring apparatus 10 includes the optical system 11, the stage 12, a memory 13, the display 14 and a controller 15.

As shown in FIG. 2, in the optical system 11, a projection optical system 35 radiates a line beam L that extends in the direction X (see FIG. 3) on a later-mentioned measurement target (later-mentioned wafer 16) mounted on the stage 12. A reception optical system 36 enables acquisition of the shape of the line beam L on the measurement target by causing the reflected line beam Rl to form images on predetermined regions (later-described reception regions) on the receiving surface 18 of the imaging device 17, the reflected line beam Rl1 being light reflected from the measurement target having been irradiated with the line beam L on a surface thereof. In the optical system 11, the imaging device 17 acquires information necessary for measuring the shape of the line beam L on the surface of the measurement target, that is, the surface shape of the measurement target (or its position coordinate) along the line beam L. The imaging device 17 acquires the information on the basis of the geometric positional relationship in the line beam L on the measurement target. A configuration of the optical system 11 will be described later.

As shown in FIG. 3, the stage 12 is provided to slide the mounted measurement target in the direction Y to change a position on the measurement target at which the projection optical system 35 (see FIG. 2) radiates the line beam L. In this example, the wafer 16 is mounted on the stage 12 as the measurement target. Some types of wafers 16 are provided with ball-shaped terminals (referred to below as bumps 19 (see FIG. 4)) formed by soldering or the like to provide wiring for each electronic component to be generated from the wafer, and the height of each of the bumps 19 needs to be managed for quality management of each of the electronic components. For this reason, the object to be measured in this example is the bump 19 (height of the bump) provided in the wafer 16.

If the wafer 16 is moved in the direction Y (see arrow A1) on the stage 12, the position on the wafer 16 (surface of the wafer 16) irradiated with the line beam L shifts in the direction opposite to the movement direction A1 (see arrow A2). Accordingly, when the wafer 16 is mounted on the stage 12, the wafer 16 can be irradiated at a region having a width equal to the width of the line beam L and extending in the direction Y. Along with the radiation, the reception optical system 36 appropriately acquires a reflected line beam Rl, and thus measurement (scanning) can be carried out for a region (see dashed-dotted line) obtained by extending, in the direction Y, an area which is acquired on the line beam L.

Thus, the measuring apparatus 10 is capable of measuring the entire region of the wafer 16 in the following manner. Specifically, the above measuring operation (scanning) is repeated while the area in which the reflected line beam Rl is obtained with the line beam L (in the direction X) by the reception optical system 36 being changed in the X direction relative to the position of the wafer 16 mounted on the stage 12. Under control of the controller 15, the stage 12 sets a speed for moving the wafer 16 according to intervals of measurement positions in the direction Y of the wafer 16 and processing speed of the imaging device 17, and slides the wafer 16 at this speed.

According to control performed by the controller 15, each piece of measured data based on an electrical signal (each piece of pixel data) outputted from the imaging device 17 is appropriately stored to and read from the memory 13. Under control of the controller 15, the display 14 displays each piece of measured data stored in the memory 13 as a numerical value or a visualized diagram (see FIGS. 5A to 5E).

The controller 15 sets the speed for sliding the wafer 16 according to intervals of measurement positions in the direction Y of the wafer 16 (measurement target) and processing speed of the imaging device 17. The controller 15 then outputs a drive signal to the stage 12 to drive the stage 12 at this speed, as well as outputs, to the imaging device 17, a signal for outputting an electrical signal (each piece of pixel data) synchronized with the sliding movement. In addition, the controller 15 converts an electrical signal (each piece of pixel data) outputted from the imaging device 17 into a shape of the line beam L on the surface of the measurement target, that is, into measured data as a position coordinate of the measurement target on the line beam L. The controller 15 carries out this conversion on the basis of a geometric positional relationship in the line beam L on the measurement target. Moreover, the controller 15 reads out the measured data stored in the memory 13 at an appropriate timing, and causes the display 14 to display the data as a numerical value or a visualized diagram (see FIGS. 5A to 5E).

The controller 15 is capable of carrying out three-dimensional measurement of the wafer 16 by sliding the wafer 16 on the stage 12 at the predetermined speed, and generating measured data on the basis of the electrical signal (each piece of pixel data) outputted from the imaging device 17 after passing through the optical system 11. A description will be given below of an example of a diagram obtained by visualizing measured data.

Firstly, as shown in FIG. 4, assuming that two of the bumps 19 (referred to below as bumps 19a and 19b) are provided on the wafer 16 being the measurement target, if the wafer 16 is slid in the direction Y on the stage 12, the part being irradiated with the line beam L relatively moves from reference numeral L1 to reference numeral L5. As a result, pieces of measured data acquired by way of the reception optical system 36 of the optical system 11 are as follows. Specifically, as shown in FIG. 5A, measured data corresponding to a line beam L1 is a flat line 20 including no variation in the direction Z′ on any point in the direction X′; as shown in FIG. 5B, measured data corresponding to a line beam L2 is the line 20 including a small protrusion 20a corresponding to the shape of an intermediate part of the bump 19a, and a protrusion 20b corresponding to the shape of an intermediate part of the bump 19b; as shown in FIG. 5C, measured data corresponding to a line beam L3 is the line 20 including a protrusion 20c corresponding to the shape of the peak of the bump 19a, and a large protrusion 20d corresponding to the shape of the peak of the bump 19b; as shown in FIG. 5D, measured data corresponding to a line beam L4 is the line 20 including a small protrusion 20e corresponding to the shape of an intermediate part of the bump 19a, and a protrusion 20f corresponding to the shape of an intermediate part of the bump 19b; and as shown in FIG. 5E, measured data corresponding to a line beam L5 is the flat line 20. Thus, by sliding the measurement target (wafer 16) on the stage 12 at a predetermined speed and appropriately generating measured data on the basis of the electrical signal (each piece of pixel data) outputted from the imaging device 17 by way of the optical system 11, three dimensional measurement of the measurement target (wafer 16) can be carried out, and measured data can be displayed on the display 14 as a visualized diagram. Note that measured data as a numerical value is obtained by combining numeric data of each point (X′, Z′ coordinates) in the visualized diagram with numeric data of the sliding position of the measurement target (wafer 16) (in the direction Y) on the stage 12. Here, by using the coordinate position in the direction Z′ (height) on the receiving surface 18 of the imaging device 17, the height of the measurement target (wafer 16) on the stage 12 in the direction Z can be represented by the following equation (1). Here, in the equation (1), the height of the bump 19b is Δh (see FIG. 4), the position coordinate of the peak of the bump 19b on the receiving surface 18 is Zd′ (see FIG. 5C), the position coordinate of the flat part of the measurement target on the receiving surface 18 is Z0′ (see FIG. 5C), the incident angle at which the line beam L radiated from the projection optical system 35 is incident on the measurement target (wafer 16) on the stage 12 is θ (see FIG. 2), and the magnification of an optical imaging system (33, 34) in the direction Z (direction Z′) is set to 1.

Δh=2(Zd′−Z0′)sin θ (1)

Thus, the height of the measurement target (wafer 16) on the stage 12 in the direction Z can be obtained from the coordinate position on the receiving surface 18.

Next, a configuration of the optical system 11 will be described. As shown in FIG. 2, the optical system 11 includes a light source 30, a collimating lens 31, a beam splitting mechanism 32, a first optical imaging system 33, a second optical imaging system 34 and the imaging device 17.

The light source 30 emits a light beam for the line beam L, and may be formed of a laser diode or the like, for example. The collimating lens 31 converts a light beam emitted from the light source 30 into the line beam L (see FIG. 3 and other drawings) that radiates the wafer 16 (measurement target) in a linear form having a predetermined width (in the direction X). A cylindrical lens or the like may be used as the collimating lens, for example. Hence, in the optical system 11, the light source 30 and the collimating lens 31 form the projection optical system 35.

In the beam splitting mechanism 32, the reflected light Rl reflected from the wafer 16 (measurement target) is caused to be split into two beams (one is referred to as Rl1 and the other is referred to as Rl2) and a half mirror or wavelength separation mirror may be used to form the beam splitting mechanism. Here, the reflected line beam Rl refers to that including information on the shape of the line beam L (see FIG. 4) on the wafer 16 (measurement target).

The first optical imaging system 33 and the second optical imaging system 34 are provided so as to correspond to the first reflected line beams Rl1, Rl2 split by the beam splitting mechanism 32, respectively. As shown in FIG. 3, the reflected line beam Rl, which is a reflected beam of the line beam L irradiated on the surface of the measurement target, is imaged on the receiving surface 18 of the imaging device 17. Thus, the shape of the line beam L on the surface of the wafer 16, that is, the shape of the measurement target (coordinate thereof) along the line beam L can be measured. The first optical imaging system 33 and the second optical imaging system 34 may be appropriately configured by use of various types of lenses based on a geographic positional relationship between the wafer 16 (line beam L irradiated thereon) mounted on the stage 12 and the receiving surface 18 of the imaging device 17. Hence, in the optical system 11, the beam splitting mechanism 32, the first optical imaging system 33, the second optical imaging system 34 and the imaging device 17 form the reception optical system 36.

In the first optical imaging system 33, and the second optical imaging system 34, as described below, the first reflected line beams Rl1, Rl2 are imaged on first regions (S₁₁ to S₄₁) (see FIG. 6) of different segments Sn (n=1 to 4) set on the receiving surface 18 of the imaging device 17. In addition, in the first optical imaging system 33 and the second optical imaging system 34, optical settings for the object for measurement (each bump 19 in the above example) in the measurement target as seen on the receiving surface 18 (each of the first regions (S₁₁) to S₄₁) being the reception region) of the imaging device 17. The optical settings are, for example, measurable ranges of an object for measurement in the measurement target (magnification) and/or resolution for the measurement target, and the like. Here, the measurable range (magnification) of the measurement target is a range capable of measuring a dimension of the measurement target (wafer 16) mounted on the stage 12 viewed in the Z direction and may be indicated by a dimension in the Z direction on the stage 12 in relation to a dimension on the receiving surface 18 of the imaging device 17 (first regions (S₁₁ to S₄₁) of each segment Sn (n=1 to 4)) in the Z′ direction. Furthermore, the resolution for the measurement target (object for measurement) is a range to be measured on the measurement target (wafer 16) mounted on the stage 12 in an extending direction of the line beam L (X direction) and may be indicated by a dimension on the stage 12 in the X direction in relation to a dimension on the receiving surface 18 of the imaging device 17 (first regions (S₁₁ to S₄₁) of each segment Sn (n=1 to 4) in the X′ direction, that is, a number of pixels viewed in the X′ direction.

The imaging device 17 is a solid-state image sensor that converts a subject image formed on the receiving surface 18 into an electrical signal (each piece of pixel data) and outputs the resultant signal. A CMOS image sensor is used as the imaging device 17, for example. The imaging device 17 includes the receiving surface 18 whose entire surface is segmented into latticed regions called pixels, and outputs acquired data formed of a group of pixel data as an electrical signal, each piece of pixel data being digital data. A positional relationship is set in the optical system 11 so that in the imaging device 17, the direction X on the stage 12 corresponds to the horizontal or lateral direction (hereinafter referred to as direction X′) on the receiving surface 18, and the direction Z on the stage 12 corresponds to the vertical direction (hereinafter referred to as direction Z′) on the receiving surface 18. Accordingly, on the receiving surface 18 (the acquired data) of the imaging device 17, the reflected line beam Rl having passed the first optical imaging system 33 or the second optical imaging system 34 basically forms a linear shape extending along the direction X′, and the height (in the direction Z) of the measurement target (wafer 16) appears as variation in the imaging position in the direction Z′. In the measuring apparatus 10 according to an embodiment of the present invention, a CMOS image sensor having the following functions is used as the imaging device 17 in order for high-speed image data processing. Note that other sensors (imaging devices) may be employed as long as the sensor has the following functions.

As shown in FIG. 6, in order to achieve high-speed image data processing, multiple segments (reference numerals S1 to S4) are set on the receiving surface 18 of the imaging device 17, multiple registers (reference numerals R1 to R4) are provided so as to correspond to the segments, and each segment is partitioned into multiple regions. For ease of understanding, the imaging device 17 in the following description has 4 segments (referred to below as first segment S1 to fourth segment S4) and 4 registers (referred to below as first register R1 to fourth register R4) set therein. In addition, each segment Sn (n=1 to 4) is partitioned into 3 regions (referred to as first, second and third regions). Each of the three regions in each segment Sn (n=1 to 4) has the same capacity as each register Rm (m=1 to 4). Each register Rm (m=1 to 4) has a dedicated output path, and in the imaging device 17, signals can be outputted simultaneously from the registers Rm (m=1 to 4).

In each segment Sn (n=1 to 4) of the receiving surface 18 of the imaging device 17, firstly, of the subject image formed on the receiving surface 18, parts of the subject image in the first regions (S₁₁ to S₄₁) are converted into electrical signals (pieces of pixel data), the electrical signals (pieces of pixel data) are collectively shifted to the corresponding register Rm (m=1 to 4), and the electrical signals (pieces of pixel data) are outputted from each register Rm (m=1 to 4). Then, parts of the subject image in the second regions (S₁₂ to S₄₂) are converted into electrical signals (pieces of pixel data), the electrical signals (pieces of pixel data) are collectively shifted to the corresponding register Rm (m=1 to 4), and the electrical signals (pieces of pixel data) are outputted from each register Rm (m=1 to 4). Finally, parts of the subject image in the third regions (S₁₃ to S₄₃) are converted into electrical signals (pieces of pixel data), the electrical signals (pieces of pixel data) are collectively shifted to the corresponding register Rm (m=1 to 4), and the electrical signals (pieces of pixel data) are outputted from each register Rm (m=1 to 4). Thus, in the imaging device 17, circuit configuration can be made simple while naturally increasing the processing speed for outputting the subject image formed on the receiving surface 18 as electrical signals (pieces of pixel data).

Additionally in the imaging device 17, according to control performed by the controller 15, electrical signals (pieces of pixel data) from the first regions (S₁₁ to S₄₁) of the segments Sn (n=1 to 4) are outputted through corresponding registers Rm (m=1 to 4), and electrical signals (pieces of pixel data) from other regions (second and third regions) are caused not to be outputted. Hence, output processing can be performed on acquired data at an even higher speed. Hereinafter, the time required for output processing is referred to as the minimum output processing time of the imaging device 17. In the measuring apparatus 10, lines for partitioning the segments Sn (n=1 to 4) follow the direction X′, and lines for partitioning the regions also follow the direction X′. As described above, in the measuring apparatus 10, the direction in which the measurement target (wafer 16) mounted on the stage 12 is scanned by the sliding movement is the direction Y, and thus the range to be measured by a single scanning operation (measuring movement) is limited by the acquisition range of the imaging device 17 in the direction X (width). Hence, as the direction X on the stage 12 corresponds to the direction X′ on the receiving surface 18, the range to be measured by a single scanning operation (measuring movement) can be maximized by using the maximum length of the receiving surface 18 in the direction X′ for measurement. Since signals can be outputted simultaneously from the registers Rm (m=1 to 4), the imaging device 17 of this example is capable of simultaneously outputting, at most, electrical signals (pieces of pixel data) from the first regions (S₁₁ to S₄₁) of 4 segments Sn (n=1 to 4) within the same amount of processing time as in the case of outputting from any one single first region, that is, the signals can be outputted simultaneously at the minimum output processing time of the imaging device 17.

With this taken into consideration, the measuring apparatus 10 as an example of the present invention uses the first regions (S₁₁ to S₄₁) of the segments Sn (n=1 to 4) as the reception regions of the receiving surface 18 in the imaging device 17, and the aforementioned first and second optical imaging systems 33 and 34 cause the first reflected line beam Rl1 and the second reflected line beam Rl2 to form images on different first regions (S₁₁ to S₄₁) from each other. In this example, as shown in FIG. 2, the first optical imaging system 33 guides the first reflected line beam Rl1 to the first region S₂₁ of the second segment S2, and the second optical imaging system 34 guides the second reflected line beam Rl2 to the first region S₃₁ of the third segment S3. Note that the regions in the segments Sn (n=1 to 4) are examples for ease of understanding and do not necessarily correspond to the positional relationship on an actual receiving surface of the imaging device. However, as described above, each of the regions in the segments Sn (n=1 to 4) extend over the whole width of the receiving surface 18 of the imaging device 17 in the direction X′. Accordingly, in the measuring apparatus 10, the whole width of each region in the segments Sn (n=1 to 4) can be used for measurement on the receiving surface 18 of the imaging device 17.

In the measuring apparatus 10, when the line beam L emitted from the projection optical system 35 is radiated on the wafer 16 (measurement target) which is mounted on the stage 12 to be appropriately slid, the reflected line beam Rl reflected therefrom is split by the beam splitting mechanism 32 while the first reflected line beam Rl1 being caused to form an image on the first region 821 of the second segment S2 in the receiving surface 18 of the imaging device 17 via the first optical imaging system 33. On the other hand, the second reflected line beam Rl2 being one of the split beam passes the first optical imaging system 34 and is caused to form an image on the first region S₃₁ in the third segment S3 on the receiving surface 18 of the imaging device 17. Under control of the controller 15, the imaging device 17 outputs, to the controller 15, electrical signals (pieces of pixel data) corresponding to the imaged first reflected line beam Rl1 through the second register R2 which corresponds to the first region 821 of the second segment S2. Under control of the controller 15, the imaging device 17 also outputs, to the controller 15, electrical signals (pieces of pixel data) corresponding to the imaged second reflected line beam Rl2 through the third register R3 which corresponds to the first region S₃₁ of the third segment S3. At this time, the output from the second register R2 corresponding to the first region S₂₁ and the output from the third register R3 corresponding to the first region S₃₁ are performed simultaneously, and the amount of time required for processing thereof is the same as the minimum output processing time of the imaging device 17.

Accordingly, in the measuring apparatus 10 of the present invention, only the minimum output processing time of the imaging device 17 is required for outputting, to the controller 15, two kinds of electrical signals (pieces of pixel data) which are: the electrical signals (pieces of pixel data) corresponding to the first reflected line beam Rl1 having passed the first optical imaging system 33; and the electrical signals (pieces of pixel data) corresponding to the second reflected line beam Rl2 having passed the second optical imaging system 34.

In this example, although the two types of optical imaging systems (the first optical imaging system and the second optical imaging system) are provided, the number of the segments set in the imaging device (receiving surface thereof) in the optical imaging systems can be increased or decreased. At this time, the following configuration may be employed. That is, according to the number of the optical imaging systems, the reflected line beam Rl is configured to be split by the beam splitting mechanism 32, the reflected line beams Rl are guided to the optical imaging systems, respectively, and then the reflected line beams Rl from the optical imaging systems are configured to form images on the different reception regions (in the above example, first regions of the segments Sn (n=1 to 4)) from each other on the receiving surface of the imaging device. Here, in each of the following examples, although for the sake of easy understanding, similarly to the above example, example in a case of splitting into two beams will be described, the number of optical imaging systems may be increased up to the number of segments set in the imaging device (receiving surface thereof), similarly to this example.

Moreover, although in the above example, an exemplar imaging device 17 in which 4 segments are set is shown and each segment is partitioned into 3 regions on the receiving surface 18, the invention is not limited to this, and the following examples may also be employed. Specifically, the imaging device 17 may otherwise be a CMOS sensor in which 16 segments are set, each segment being partitioned into 8 regions; a CMOS sensor in which 12 segments are set, each segment being partitioned into 4 regions; a CMOS sensor in which 16 segments are set, each segment being partitioned into 4 regions; or the like.

Furthermore, in the above example, the first region of each segment is used as the reception region on the receiving surface 18. The measuring apparatus 10 according to the present invention employs the imaging device 17 in which multiple segments are set and which has the above-mentioned functions, and thus even when all of the regions in the segment are used as the reception regions on the receiving surface 18, the output processing can be performed much faster than in a case of employing an imaging device not having the above-mentioned functions. Hence, all of the regions in the segment may be used as the reception regions on the receiving surface 18, or an arbitrary number of regions in the segment may be used as the reception regions on the receiving surface 18.

In addition, in the above example, the first region of each segment is used as the reception region on the receiving surface 18. However, when an electrical signal (each piece of pixel data) from the second region of each segment is used while not outputting electrical signals (pieces of pixel data) from the other regions (first and third regions), for example, the output processing can be performed in approximately the same amount of time as in the case of using only the first region of each segment. For this reason, any of the regions in the segment may be used as the reception region on the receiving surface 18. Accordingly, as mentioned above, in the case of using a certain number of regions in the segment as the reception regions in the receiving surface 18, any one or more of the regions may be used as the reception regions regardless of the order of the regions from which the signals are read from the corresponding register.

The measuring apparatus according to an embodiment of the present invention may further include an entering beam controlling mechanism provided between the optical imaging system and the imaging device, and configured to cause only the reflected line beam from the optical imaging system corresponding to each of the reception regions to enter the imaging device. The entering beam controlling mechanism may be a light shielding member configured to partition the receiving surface according to each of the reception regions. The entering beam controlling mechanism may be a guiding device configured to guide beams to the reception regions, respectively. The entering beam controlling mechanism may be a filter configured to transmit only beams within a predetermined wavelength range of the plurality of beams having different wavelengths from each other.

### Example 1

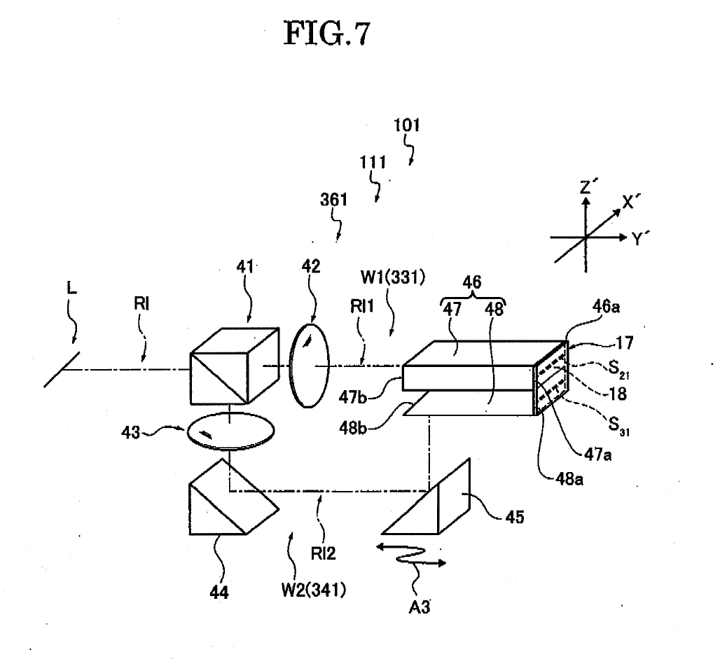

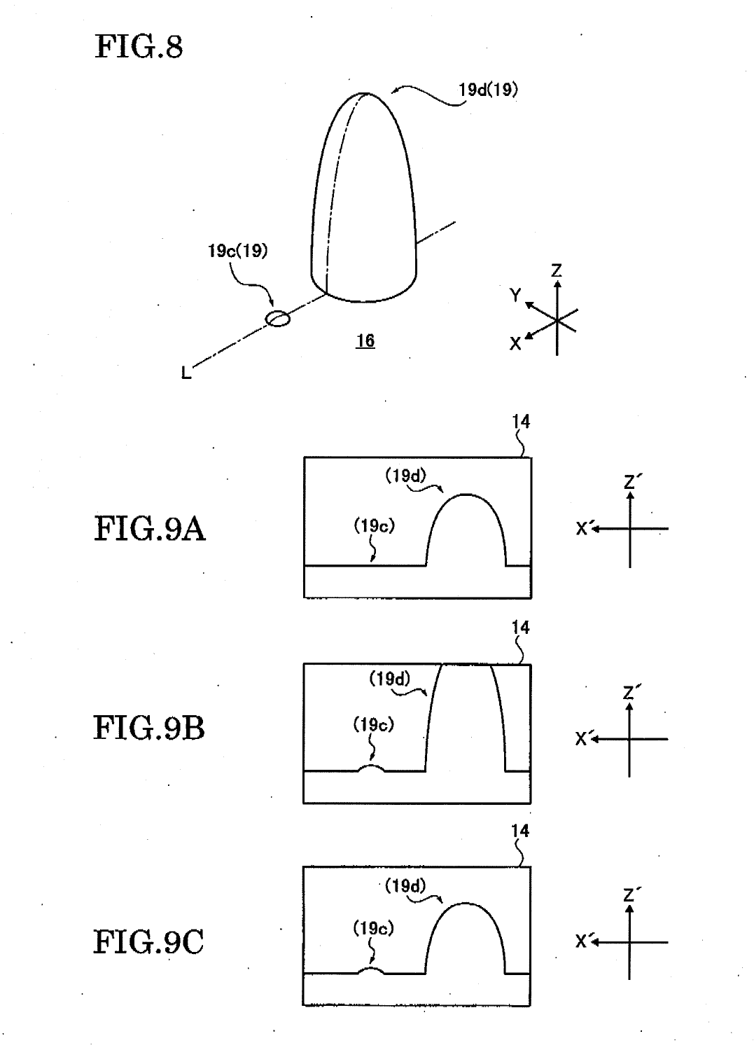

Next, a description will be given of a measuring apparatus 101 of Example 1 which is an example of a specific configuration of a reception optical system 361 in the measuring apparatus according to the present invention, Note that since basic configuration of the measuring apparatus 101 of Example 1 is the same as the measuring apparatus 10 described in the above example, parts having the same configuration are assigned the same reference numerals, and details thereof are omitted. FIG. 7 is a configuration diagram schematically showing the reception optical system 361 in an optical system 111. FIG. 8 is a view schematically showing a state of the object for measurement (bumps 19c, 19d) in the measurement target (wafer 16) to describe measurement in the measuring apparatus 101. FIGS. 9A to 9C are explanatory views each schematically showing a state where measured data measured from the object of measurement (bumps 19 c and 19d) shown in FIG. 8 is displayed on a display 14 as a visualized diagram. FIG. 9A shows measured data acquired from a side corresponding to a first optical path w1; FIG. 9B shows measured data acquired from a side corresponding to a second optical path w2; and FIG. 9C shows a state where the pieces of measured data shown in FIGS. 9A and 9E are combined.

In the optical system 111 in the measuring apparatus 101 of Example 1, a projection optical system 351, includes a light source 30 and a collimating lens 31 (see FIG. 2) as in the above example. Thus, in the measuring apparatus 101, a beam having a single wavelength emitted from a single light source 30 is referred to as a line beam L, and is radiated on a wafer 16 (measurement target) mounted on a stage 12.

The reception optical system 361 in the optical system 111 includes a splitting prism 41, a first lens 42, a second lens 43, a first reflecting prism 44 and a second reflecting prism 45, an optical guiding device 46 and an imaging device 17.

The splitting prism 41 constitutes an optical splitting mechanism (see reference numeral 32 in FIG. 2) which splits, into two, a beam reflected from the wafer 16. In Example 1, a half mirror is employed since the line beam L is formed of a single wavelength. The splitting prism 41 splits the beam (reflected line beam Rl) having been reflected from the wafer 16 and proceeding in a direction Y′ into two paths including a first optical path w1 that causes the beam to proceed straight ahead, and a second optical path w2 that causes the beam to proceed in a direction orthogonal to the first light path w2 (in a direction along a X′-Z′ plane). In the following description, the reflected line beam Rl passing through the first optical path w1 is referred to as a first reflected line beam Rl1, and the reflected line beam Rl passing through the second optical path w2 is referred to as a second reflected line beam Rl2.

The first lens 42 and the optical guiding device 46 (first optical guiding prism 47, described hereinafter) are provided in the first optical path w1. In the first optical path w1, the first reflected line beam Rl1 having passed through the splitting prism 41 enters the optical guiding prism 46 (first optical guiding prism 47, described hereinafter) via the first lens 42.

Meanwhile, the second lens 43, the first reflecting prism 44, the second reflecting prism 45 and the optical guiding device 46 (second optical guiding prism 48, described hereinafter) are provided in the second optical path w2. In the second optical path w2, the second reflected line beam Rl2 reflected by the splitting prism 41 in a direction orthogonal to the first light path w1 proceeds to the first reflecting prism 44 via the second lens, and is reflected by the first reflecting prism 44 to proceed in the direction Y′ to proceed to the second reflecting prism 45, is reflected by the second reflecting prism 45 in the direction orthogonal to the first optical path w1 and then enters the optical guiding device 46 (second optical prism 48, described hereinafter).

The optical guiding device 46 guides the first reflected line beam Rl1 having passed the first optical path w1 and the second reflected line beam Rl2 having passed the second optical path w2 to different reception regions from each other on the receiving surface 18 of the imaging device 17. Here, the reception regions refer to regions in each of the segments used to acquire the reflected line beam Rl (the electrical signal (each piece of pixel data)) on the receiving surface of the imaging device 17, that is, at least one or more regions into which each segment is partitioned, end are appropriately set according to requirements in the overall inspection speed (throughput) and the inspection accuracy, while considering the output processing time of the imaging device 17. In this example, in order for high speed (the minimum output processing time of the imaging device 17) and simultaneous processing to be performed in the imaging device 17, the reception regions are set to regions for which transfer processing is firstly performed in the segments on the receiving surface of the imaging device. In the receiving surface 18 of the imaging device 17 in the above example, any of the first regions (S₁₁ to S₄₁) in the segments Sn (n=1 to 4) are set as the reception regions. In Example 1, the first reflected line beam Rl1 having passed the first optical path w1 is guided to the first region S₂₁ of the second segment 52 in the receiving surface 18 of the imaging apparatus 17 and the second reflected line beam Rl2 having passed the second optical w2 is guided to the first region S₃₁ of the third segment S3 in the receiving surface 18 of the imaging device 17.

In Example 1, the optical guiding device 46 is configured such that the first optical guiding prism 47 and the second optical guiding prism 48 are superimposed with each other one above the other in Z′ direction viewed on the imaging device 17 and one end 46a contacts with the receiving surface 18 of the imaging device 17. The optical guiding prism 47 is a flat glass having a plate-like thin flat rectangular shape and an end surface 47a at a side of the other end 46a is parallel to an opposite end surface 47b. The optical guiding prism 48 is in a flat plate thin rectangular shape. An end surface 48a at the other end is flush with the end surface 47a of the first guiding prism 47 so as to be in a same plane, and an end surface 48b at the other side is inclined. The end surface 48b is, in Example 1, formed by a flat plane having an inclined angle of 45 degrees from an orthogonal state according to a positional relationship between a configuration of the second optical path w2 and the imaging device 17, the configuration of the second optical path w2 including the splitting prism 41, the first reflecting prism 44 and the second reflecting prism 45. In other words, an upper side of the second optical guiding prism 48, that is, a side facing the first optical guiding prism 47 is in a rotated state at 45 degrees about X′ direction as an axis from the X′-Y′ plane so as to be close to the imaging device 17. Therefore, the second reflected line beam Rl2, which is reflected on the second reflecting prism 45 and proceeds in the Z′ direction is guided so as to proceed in the second optical guiding prism 48 toward the receiving surface 18 (corresponding reception region) of the imaging device 17. The end surface 48b has functions of reflecting, in the Y′ direction in the second optical guiding prism 48, the second reflected line beam Rl2 which is reflected on the second reflecting prism 45 in the second light path w2 and proceeds in the Z′ direction, and of preventing unintended beams, which proceeds from outside toward the end surface 48b (for example, beams proceeding toward the end surface 48b from a side of the measurement target (wafer 16)), from entering the second optical guiding prism 48.

The end surface 47a of the first optical guiding prism 47 has a surface which is larger than at least the first region S₂₁ of the second segment S2 in the receiving surface 18 of the imaging device 17 and the end surface 48a of the second optical guiding prism 48 has a surface which is larger than at least the first region S₃₁ of the third segment S3 in the receiving surface 18 of the imaging device 17.

Moreover, the optical guiding device 46 has a function of preventing an unintended beam from entering each of the reception regions in the receiving surface of the imaging device. Here, since the optical guiding device 46 is formed by superimposing two plate glasses (47, 48) each having a substantially rectangular shape, basically, it is possible to prevent an unintended beam from entering each reception region by effects of refraction or total reflection on each surface according to a shape or material thereof. This is particularly effective because in the reception optical system 36, flare beams generated in the first optical path w1, or the like possibly enter the first region S₂₁ of the second segment S2 and/or the first region S₃₁ of the third segment S3, and flare beams generated in the second optical path w2, or the like possibly enter the first region S₃₁ of the third segment S3 and/or the first region S₂₁ of the second segment S2.

Furthermore, in Example 1, although showing the drawings is omitted, a light shielding part having a function of a light absorbing effect or a light scattering effect is provided at a boundary surface between the two plate glasses (47, 48). The light shielding part can be easily provided by applying material having the light absorbing effect to at least one surface of surfaces being provided with contact between the first optical guiding prism 47 and the second optical guiding prism 48, by forming a surface configuration having the light scattering effect at the at least one surface, or by disposing a material having the light absorbing effect or the light scattering effect between both of the plate glasses (47, 48).

In the reception optical system 361 in Example 1, the first reflected line beam Rl1 having passed the first optical path w1 and the second reflected line beam Rl2 having passed the second optical path w2 are configured such that only the measurable range (magnification) in the height direction (the Z direction) for the object for measurement (each bump 19, in the above example) of the measurement target is different from each other. Specifically, the first reflected line beam Rl1 having passed the first optical path w1 is set so as to have lower magnification than that of the second reflected line beam Rl2 by effect of the first lens 42 in the first optical path w1 viewed on the receiving surface 18 of the imaging device 17 and the second reflected line beam Rl2 having passed the second optical path w2 is set so as to have higher magnification than that of the first reflected line beam Rl1 by effect of the second lens 43 in the second optical path w2. In Example 1, as an example, in the first optical path w1, the height (total number of pixels) in the Z′ direction in the first region S₂₁ of the second segment S2 corresponds to 100 μm in the Z direction on the wafer 16 (see FIG. 3), and in the second optical path w2, the height (total number of pixels) in the Z′ direction in the first region S₃₁ of the third segment S3 corresponds to 100 μm in the Z direction on the wafer 16.

Furthermore, the resolutions in the X direction (range to be measured in the X direction), in the wafer 16 mounted on the stage 12, for the first reflected line beam Rl1 having passed the first optical path w1 and the second reflected line beam Rl2 having passed the second optical path w2 are set to be equal to each other. In other words, the equal width in the wafer 16 for the first reflected line beam Rl1 and the second reflected line beam Rl2 is imaged (reflected) in the equal range on the first region S₂₁ of the second segment S2 and the first region S₃₁ of the third segment S3 in the X′ direction. Therefore, in the reception optical system 361 of Example 1, the first optical path w1 in which the first lens 42 is provided forms the first imaging optical system 331 and the second optical path w2 in which the second lens 43 is provided forms the second imaging optical system 341. The second optical path w2 is configured so as to have high magnification. This is because magnification can be changed by a ratio of lengths of the optical paths before and after the lens and therefore, in a case where the lens configuration is equal to each other, the longer a length of the optical path is, the higher magnification is easily obtained. In addition, the magnification can be arbitrarily set by lens property and a ratio of the length of the optical paths before and after the lens. Accordingly, the magnification may be set regardless of the lengths of the optical paths and, for example, in the configuration of Example 1, the second optical path w2 may be set to have lower magnification.

The reception optical system 361 of Example 1 is configured as described above, and therefore easy setting and adjusting when mounting the reception optical system 361 on the measuring apparatus 101 can be achieved. This will be explained below. Firstly, the reception optical system 361 is formed by assembling each part as described above. Then, in the measuring apparatus 101, a position of the reception optical system 361 is adjusted such that the reflected line beam Rl as a reflected beam from a reference position on the wafer 16 mounted on the stage 12 enters or is imaged or forms an image on a reference position in the first region S₂₁ of the second segment S2 via the first optical path w1. Then, a position of the second reflecting prism 45 is adjusted (see arrow A3) such that the second reflected line beam. Rl2 having passed the second optical path w2 split by the splitting prism 41 from the first optical path w1 enters or is imaged or forms an image on a reference position in the first region S₃₁ of the third segment 53. In the adjustment according to the position of the second reflecting prism 45, when the second reflecting prism 45 is moved in a positive direction of the Y′ direction, the image on the receiving surface 18 is moved upwardly (in a positive direction of the Z′ direction), and when the second reflecting prism 45 is moved in a negative direction of the Y′ direction, the image on the receiving surface 18 is moved downwardly (in a negative direction of the Z′ direction). Moreover, when rotating the second reflecting prism 45 about the Z′ direction, a proceeding direction of the second reflected line beam Rl2 (a direction entering the receiving surface 18) in relation to the Y′ direction in the second optical guiding prism 48 can be adjusted. In this adjustment, appropriate measurements can be achieved when producing the measuring apparatus 101. Furthermore, this position adjustment may be automatically performed by the controller 15 (for example, performed by mounting the measurement target as a reference on the stage 12 and causing the imaging device 17 to acquire the reflected line beam Rl from the measurement target, and the like) and also may be manually performed.

In the measuring apparatus 101 employing the above described reception optical system 361, two pieces of measurement data in which only measurable ranges (magnifications) of the object for measurement (each bump 19 in the above example) in the measurement target are different from each other can be acquired simultaneously so that it is possible to separately or simultaneously display the respective data or to combine both of the two pieces of measurement data and display the combined data on the display 14. This will be explained as follows.

As shown in FIG. 8, the wafer 16 as the measurement target has two bumps 19c and 19d, which have largely different sizes from each other. The bump 19c has a height (in the Z direction) of 3 μm and the bump 19d has a height (in the Z direction) of 60 μm, for example.

In the measurement data acquired from the first optical path w1 side (the first imaging optical system 331), a height (total number of pixels) in the Z′ direction in the first region 521 of the second segment 52 corresponds to 100 μm in the Z direction on the wafer 16. Accordingly, as shown in FIG. 9A, the bump 19d having the height of 60 μm is within the appropriate measurable range (magnification) so that the measurement result of 60 μm can be acquired. On the other hand, the bump 19c having the height of 3 μm is within the inappropriate measurable range (magnification), that is, the bump 19c is too small to be measured. Accordingly, as shown in FIG. 9A, the bump 19c cannot be distinguished from noise and therefore the height of the bump 19c cannot be measured or measurement result of the height includes extremely large error.

In the measurement data acquired from the second optical path w2 side (the second imaging optical system 341), a height (total number of pixels) in the Z′ direction in the first region S₃₃ of the third segment 53 corresponds to 10 μm in the Z direction on the wafer 16. Accordingly, as shown in FIG. 9B, the bump 19c having the height of 3 μm is within the appropriate measurable range (magnification) so that the measurement result of 3 μm can be acquired. On the other hand, the bump 19d having the height of 60 μm is within the inappropriate measurable range (magnification), that is, the bump 19d is too large to be measured. Accordingly, as shown in FIG. 9B, only the measurement result in that the height exceeds the measurable range or is the measurable range or more is acquired and the height cannot be acquired.

However, in the measuring apparatus 101, since the above described both pieces of the measurement data can be acquired in one scanning (measurement operation), appropriate measurement results (heights) for both pieces of the measurement data for the first optical path w1 and the second optical path w2 can be acquired. Thereby, in the measuring apparatus 101, under the control of the controller 15, when the measurement data is displayed on the display 14 as a visualized diagram, as shown in FIG. 9C, it is possible to display a diagram in which both of the measurement results (heights) are combined. The diagram in which both of the measurement results (heights) are combined has same resolution in the X direction on the measurement target (wafer 16) in Example 1, and in any measurement data acquired from any imaging optical system, X-coordinate for the same measurement target is equal. Accordingly, measurement data acquired from the imaging optical system having appropriate measurable range (magnification) for the measurement target (bump 19e and bump 19d) may be simply displayed. In this example, a diagram based on the measurement data acquired from the second optical path w2 is displayed for the bump 19c and a diagram based on the measurement data acquired from the first optical path w1 is displayed for the bump 19d. At this time, in the controller 15, the imaging optical system having an appropriate measurable range (magnification) for the measurement target (bump 19c and bump 19d, in this example) is selected, and, for example, the imaging optical system in which the measurement data is a large numerical value within measurable height may be preferentially selected. Moreover, in the combined diagram, a size relationship of the diagram to be displayed may be corrected based on the measurement data such that an image of an actual size relationship in a plurality of measurement targets is not detracted. Thereby, the size relationship according to an actual scale size is not perfectly matched but both of the heights can be understood at a glance.

In the measuring apparatus 101 of Example 1, two pieces of the measurement data having different measurable range (magnification) in the Z direction can be acquired at one measurement operation, that is, one scanning while the resolution in the X direction being equal to each other. Therefore, substantial measurable range (magnification) can be expanded without decreasing a measurement accuracy. At this time, in order to acquire two pieces of measurement data, the first reflected line beam Rl1 having passed the first optical path w1 is imaged on the first region S₂₁ of the second segment S2 on the receiving surface of the imaging device 17 and the second reflected line beam Rl2 having passed the second optical path w2 is imaged on the first region S₃₁ of the segment S3 on the receiving surface 18 of the imaging device 17. Therefore, the two pieces of the measurement data can be processed simultaneously and at extremely high speed (in a minimum output processing time in the imaging device 17) so that the time required for measurement is prevented from increasing.

In the measuring apparatus 101 of Example 1, the end 46a at an end side of the optical guiding device 46 is in contact with the receiving surface 18 of the imaging device 17. Therefore, according to an effect of guiding beams and an effect of preventing unintended beams from entering from outside by the optical guiding device 46, only the reflected line beam Rl having passed the imaging optical system corresponding to each reception region (the first region S₂₁ of the second segment 52 and the first region S₃₁ of the third segment 83, in Example 1) on the receiving surface 18 of the imaging device 17 can be imaged on or enter the imaging device. Thereby, a plurality of pieces of measurement data (two pieces of measurement data each having a different measurable range from each other, in Example 1) according to a plurality of imaging optical systems having different optical settings for the object for measurement (each bump 19, in the above example) of the measurement target can be appropriately acquired.

Furthermore, in the measuring apparatus 101 of Example 1, as the reception optical system 361, each part (splitting prism 41, first lens 42, second lens 43, first reflecting prism 44, second reflecting prism 45, optical guiding device 46, and imaging device 17) is assembled. Then, the reception optical system 361 is mounted while a position of the reception optical system 361 being adjusted such that the reflected line beam Rl as a reflected beam from a reference position on the measurement target (wafer 16) is imaged on or enters a reference position on the first region S₂₁ of the second segment 52 via the first optical path w1. Then, only by adjusting a position of the second reflected prism 45, appropriate measurement can be performed.

In the measuring apparatus 101 of Example 1, two pieces of measurement data, in which only measurable ranges are different from each other for the object for measurement (each bump 19, in the above example) of the measurement target can be simultaneously acquired and respective measurement data may be displayed separately or simultaneously on the display 14 or may be combined so that the combined data may be displayed on the display 14. Therefore, measurement results with substantially expanded measurable range (magnification) can be understood at a glance.

Accordingly, in the measuring apparatus 101 of Example 1, the time required for measurement is not increased and a plurality of pieces of measurement data with different optical settings for the object for measurement (each bump 19) of the measurement target (wafer 16) can be acquired.

Moreover, in Example 1, although the reception optical system 361 is configured using the optical guiding device 46, the reception optical system is not limited thereto, that is, may be configured using a light shielding part 49 as used in the following Example 2.

### Example 2

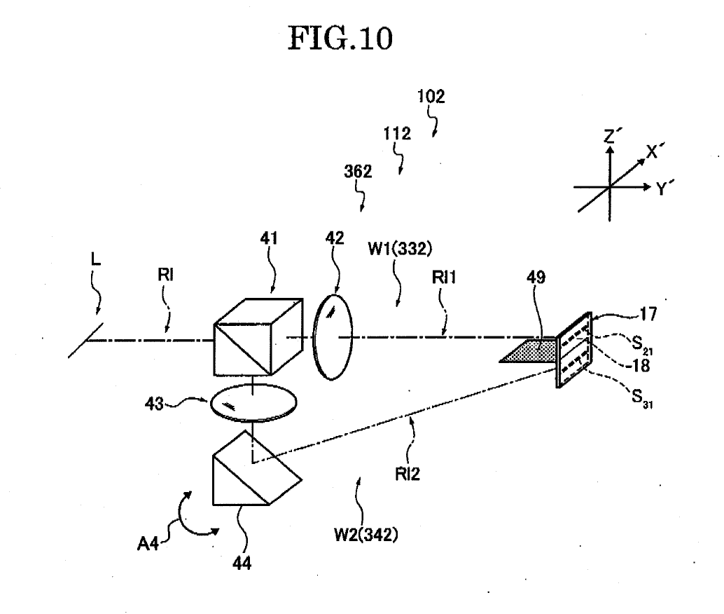

Next, a description will be given of a measuring apparatus 102 of Example 2 which is another example of a specific configuration of a reception optical system 362 in the measuring apparatus according to the present invention. Note that since basic configuration of the measuring apparatus 102 of Example 2 is the same as the measuring apparatuses 10 and 101 described in the above Example 1, parts having the same configuration are assigned the same reference numerals, and details thereof are omitted. FIG. 10 is a configuration diagram schematically showing the reception optical system 362 in an optical system 112.

In the optical system 112 in the measuring apparatus 102 of Example 2, a projection optical system 35 similarly to the projection optical system 11 is used and irradiate the wafer 16 (measurement target) with a line beam having a single wavelength. The reception optical system 362 of the optical system 112 includes a splitting prism 41, a first lens 42, a second lens 43, a first reflecting prism 441 and a light shielding part 49 and an imaging device 17.

Similarly to the measuring apparatus 101 of Example 1, the splitting prism 41 splits the reflected line beam Rl which is reflected from the wafer 16 and proceeds in the Y′ direction into two beams, that is, the first reflected line beam Rl1 proceeding in the first optical path w1 and the second reflected line beam Rl2 proceeding in the second optical path w2.

The first lens 42 is provided in the first optical path w1. In the first optical path w1, the first reflected line beam Rl1 having passed through the splitting prism 41 enters the receiving surface 18 (first region S₂₁ of the second segment S2) of the imaging device 17 via the first lens 42.

Meanwhile, the second lens 43, and the first reflecting prism 441 are provided in the second optical path w2. In the second optical path w2, the second reflected line beam Rl2 reflected by the splitting prism 41 in a direction orthogonal to the first light path w1 proceeds to the first reflecting prism 441 via the second lens 43, and is reflected by the first reflecting prism 441 and then enters the receiving surface 18 (first region S₃₁ of the third segment S3) of the imaging device 17.

In the reception optical system 362 of Example 2, the shielding part 49 instead of an optical guiding device is provided. This is, as described below, because the second optical path w2 is adjusted by rotating the first reflecting prism 441 about the X′ direction and therefore the adjustment can be more easily achieved in a case of configuration using the light shielding part 49 than in a case of configuration using the optical guiding device. Accordingly, similarly to Example 1, the optical guiding device may be provided.

The shielding part 49 is configured to cause only the first reflected line beam Rl1 having passed the first optical path w1 to form an image on the first region S₂₁ of the second segment S2 on the receiving surface 18 of the imaging device 17 while causing only the second reflected line beam R12 having passed the second optical path w2 to form an image on the first region S₃₁ of the third segment S3 on the receiving surface 18 of the imaging device 17. The shielding part 49 is formed by a plate like member having a light absorbing effect and is provided in contact with the receiving surface 18 at one side so as to partition the first optical path w1 and the second optical path w2 without interference between the first optical path w1 and the second optical path w2.

In the reception optical system 362 in Example 2, similarly to the reception optical system 361 of Example 1, only the measurable ranges (magnification) for the object for measurement (each bump 19, in the above example) of the measurement target are different from each other in the first reflected line beam Rl1 having passed the first optical path w1 and the second reflected line beam Rl2 having passed the second optical path w2. Accordingly, in the reception optical system 362 of Example 2, the first optical path w1 in which the first lens 42 is provided constitute a first imaging optical system 332 and the second optical path w2 in which the second lens 48 is provided constitute a second imaging optical system 342.

The reception optical system 362 of Example 2 is configured as described above, and therefore easy setting and adjusting when mounting the reception optical system 862 on the measuring apparatus 102 can be achieved. This will be explained below. Firstly, the reception optical system 862 is formed by assembling each part as described above. Then, in the measuring apparatus 102, a position of the reception optical system 362 is adjusted such that the reflected line beam Rl as a reflected beam from a reference position on the wafer 16 mounted on the stage 12 enters or is imaged or forms an image on a reference position in the first region S₂₁ of the second segment S2 via the first optical path w1. Then, a rotating state of the first reflecting prism 441 is adjusted (see arrow A4) such that the second reflected line beam Rl2 having passed the second optical path w2 split by the splitting prism 41 from the first optical path w1 enters or is imaged or forms an image on a reference position in the first region S₃₁ of the third segment S3. In the adjustment according to the rotating state of the first reflecting prism 441, an imaging position or an entering position of the second reflected line beam Rl2 having passed the second optical path w2 can be adjusted by rotating the first reflecting prism 441 about the X′ direction. If this adjustment is performed when producing the measuring apparatus 102 is performed, an appropriate measurement can be achieved.

In the measuring apparatus 102 of Example 2 employing the above described reception optical system 362, similarly to the measuring apparatus 101 of Example 1, two pieces of measurement data in which only measurable ranges (magnifications) of the object for measurement (each bump 19 in the above example) in the measurement target are different from each other can be acquired simultaneously so that it is possible to separately or simultaneously display the respective data on the display 14 or to combine both of the two pieces of measurement data and display the combined data on the display 14.

In the measuring apparatus 102 of Example 2, two pieces of the measurement data having different measurable ranges (magnifications) in the Z direction can be acquired at one measurement operation, that is, one scanning while the resolution in the X direction being equal to each other. Therefore, substantial measurable range (magnification) can be expanded without decreasing a measurement accuracy. At this time, in order to acquire two pieces of measurement data, the first reflected line beam Rl1 having passed the first optical path w1 is imaged on the first region S₂₁ of the second segment 52 on the receiving surface 18 of the imaging device 17 and the second reflected line beam Rl2 having passed the second optical path w2 is imaged on the first region S₃₁ of the segment S3 on the receiving surface 18 of the imaging device 17. Therefore, the two pieces of the measurement data can be processed simultaneously and at extremely high speed (in a minimum output processing time in the imaging device 17) so that the time required for measurement is prevented from increasing.

In the measuring apparatus 102 of Example 2, one side of the light shielding part 49 is in contact with the receiving surface 18 of the imaging device 17. Therefore, according to an effect of light shielding, only the reflected line beam Rl having passed the imaging optical system corresponding to each reception region (the first region S₂₁ of the second segment 52 and the first region S₃₁ of the third segment S3, in Example 2) on the receiving surface 18 of the imaging device 17 can be imaged on or enter the imaging device. Thereby, a plurality of piece's of measurement data (two pieces of measurement data each having a different measurable range from each other, in Example 2) according to a plurality of imaging optical systems having different optical settings for the object for measurement (each bump 19, in the above example) of the measurement target can be appropriately acquired.

Furthermore, in the measuring apparatus 102 of Example 2, as the reception optical system 362, each part (splitting prism 41, first lens 42, second lens 43, first reflecting prism 441, light shielding part 49, and imaging device 17) is assembled. Then, the reception optical system 362 is mounted while a position of the reception optical system 362 being adjusted such that the reflected line beam Rl as a reflected beam from a reference position on the measurement target (wafer 16) is imaged on or enters a reference position on the first region S₂₁ of the second segment S2 via the first optical path w1. Then, only by adjusting a rotating state of the first reflected prism 441, appropriate measurement can be performed.

In the measuring apparatus 102 of Example 2, two pieces of measurement data, in which only measurable ranges are different from each other for the object for measurement (each bump 19, in the above example) of the measurement target can be simultaneously acquired and respective measurement data may be displayed separately or simultaneously on the display 14 or may be combined so that the combined data may be displayed on the display 14. Therefore, measurement results with substantially expanded measurable range (magnification) can be understood at a glance.

Accordingly, in the measuring apparatus 102 of Example 2, the time required for measurement is not increased and a plurality of pieces of measurement data with different optical settings for the object for measurement (each bump 19) of the measurement target (wafer 16) can be acquired.

### Example 3

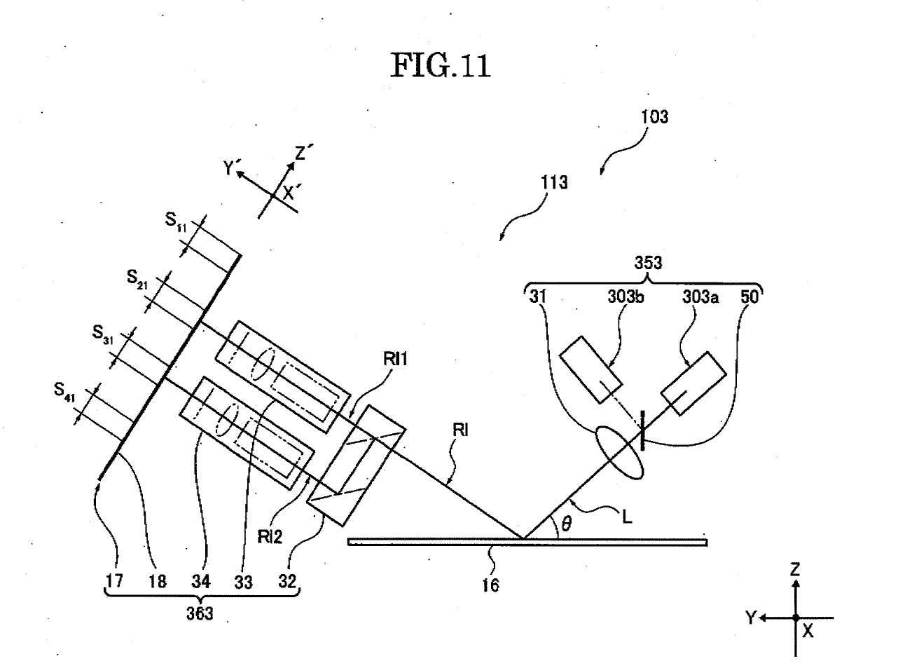

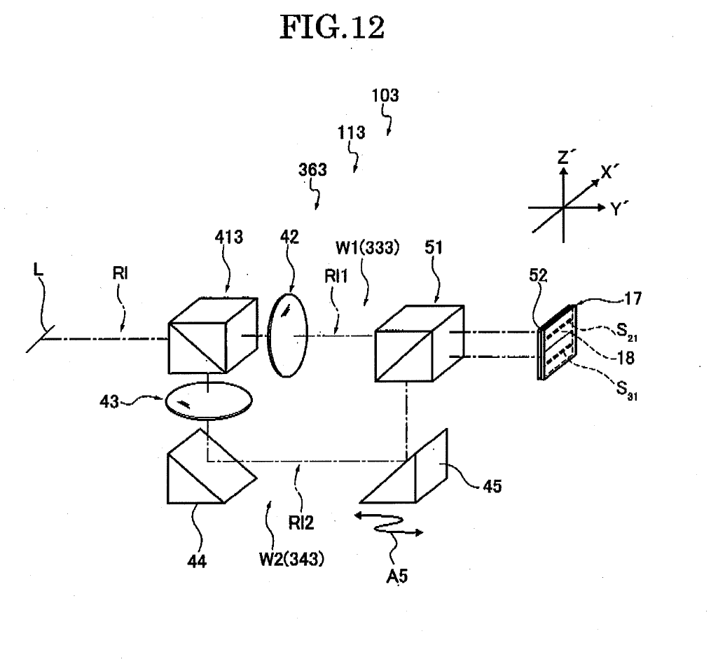

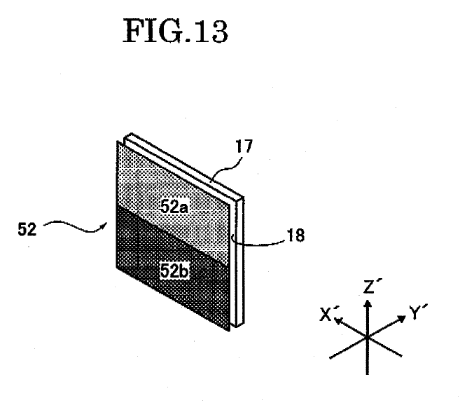

Next, a description will be given of a measuring apparatus 103 of Example 3 which is another example of a specific configuration of a reception optical system 363 in the measuring apparatus according to the present invention. Note that since basic configuration of the measuring apparatus 103 of Example 3 is the same as the measuring apparatuses 10 and 101 described in the above Example 1, parts having the same configuration are assigned the same reference numerals, and details thereof are omitted. FIG. 11 is an explanatory view schematically showing a relationship between the optical system 113 and the measurement target (wafer 16) in the measuring apparatus 103 of Example 3 similarly to FIG. 2. FIG. 12 is a configuration diagram schematically showing the reception optical system 363 in the optical system 113. FIG. 13 is an explanatory view schematically showing a filter 52 provided on the imaging device 17.

The optical system 113 in the measuring apparatus 103 of Example 3 is, as shown in FIG. 11, the projection optical system 353 includes two light sources 303a and 303b, a wavelength combining mirror 50 and a collimating lens 31. In the projection optical system 353, the light source 303a emits a beam having a different wavelength from the light source 303b. This is because of two aims, one is, in the reception optical system 113 of the optical system 113, as described below, since two imaging optical systems are provided, to split the reflected line beam Rl by the splitting prism 41, and the other is for the beam to selectively enter each reception region on the receiving surface 18 of the imaging device 17. The beams emitted from the light sources 303a and 303b are, as described below, form a single line beam L. Since it is necessary to receive the reflected line beam Rl being a reflected beam from the measurement target (wafer 16) on the imaging device 17, the wavelengths are set so as to be different from each other within a receivable wavelength range (sensitivity) in the imaging device 17. In Example 3, on the assumption that it is possible to split beams and cause the beams selectively entering the imaging device, the wavelengths are as possible as close to each other. This is because the cost of the imaging device 17 is increased as the receivable wavelength range (sensitivity) of the imaging device 17 is expanded. The light sources 303a and 303b are not limited to those in the above example and it is only required that different wavelengths within the receivable wavelength range (sensitivity) on the imaging device 17 to be used may be used.

In this projection optical system 353, the wavelength combining mirror 50 and the collimating lens 31 are provided on an optic axis of the beam emitted from the light source 303a, and a radiation position on the stage 12 is set on the optic axis. The light source 303b is positioned so that the beam emitted therefrom is reflected by the wavelength combining mirror 50 to then proceed on the optic axis of the beam emitted from the light source 303a, toward the collimating lens 31. Accordingly, the wavelength combining mirror 50 is set to allow the beam from the light source 303a to pass through, and to reflect the beam from the light source 303b. The collimating lens 31 converts the beams emitted from the light sources 303a and 303b, which are caused to proceed on the same optic axis by the wavelength combining mirror 50, into a single line beam L that is radiated on the measurement target (wafer 16) mounted on the stage 12. Accordingly, in the measuring apparatus 103, beams having 2 different wavelengths emitted from 2 light sources 303a and 303b are regarded as the line beam L on the same optic axis, and radiated on the measurement target (wafer 16) mounted on the stage 12.

The reception optical system 363 in the optical system 113 includes, as shown in FIG. 12, the splitting prism 413, the first lens 42, the second lens 43, the first reflecting prism 44, the second reflecting prism 45, the combining prism 51, the filter 52 and the imaging device 17.

The splitting prism 413 constitutes the optical beam splitting mechanism (see reference number 32 in FIG. 11) configured to split a beam (reflected line beam Rl) which is reflected from a wafer 16 (measurement target) into two beams. In Example 3, the line beam L is formed by combining beams having two wavelengths and therefore a wavelength separation mirror is used. The splitting prism 413 is set such that the beams having the wavelength of the light source 303b is reflected while the splitting prism 413, in Example 3, transmits the beams having the wavelength of the light source 303a. The splitting prism 413 splits the reflected line beam Rl, which is reflected from the measurement target (wafer 16) and proceed in the Y′ direction into two optical paths, that is, the first optical path w1 on which the first reflected line beam Rl1 proceed and the second optical path w2 on which the second reflected line beam Rl2 proceeds in a direction orthogonal to the first optical path w1.

In the first optical path w1, the first lens 42 and the combining prism 51 are provided. In the first optical path w1, the first reflected line beam Rl1 passing through the splitting prism 413 enters the combining prism 51 via the first lens 42.

In the second optical path w2, the second lens 43, the first reflecting prism 44, the second reflecting prism 45 and the combining prism 51 are provided. In the second optical path w2, the second reflected line beam Rl2 reflected by the splitting prism 413 in the direction orthogonal to the first light path w1 proceeds to the first reflecting prism 44 via the second lens 43, and is reflected by the first reflecting prism 44 in the Y′ direction to proceed to the second reflecting prism 45, is reflected by the second reflecting prism 45 in the direction orthogonal to the first optical path w1 and then enters the combining prism 51.

The combining prism 51 causes the first reflected line beam Rl1 having passed the first optical path w1 and the second reflected line beam Rl2 having passed the second optical path w2 to proceed at a small interval in the Y′ direction and guides them to different reception regions (first regions (S₁₁ to S₄₁) in the segments Sn (n=1 to 4) from each other on the receiving surface 18 of the imaging device 17. In Example 3, the first reflected line beam Rl1 having passed the first optical path w1 is guided to the first region S₂₁ of the second segment S2 in the receiving surface 18 of the imaging apparatus 17 and the second reflected line beam Rl2 having passed the second optical w2 is guided to the first region S₃₁ of the third segment 53 in the receiving surface 18 of the imaging device 17. In Example 3, the combining prism 51 uses a wavelength separation mirror which is set such that the beams having the wavelength of the light source 303b is reflected while the splitting prism 413 transmits the beams having the wavelength of the light source 303a. It is necessary only to guide the first and second reflected line beams Rl1, Rl2 as described above, and therefore a half mirror or the like may be used as the splitting prism 413 and the combining prism 51.

In the reception optical system 363 in Example 3, only the measurable ranges (magnification) in a height direction (in the Z direction) of the object for measurement (each bump 19, in the above example) of the measurement target are different from each other in the first reflected line beam Rl1 having passed the first optical path w1 and the second reflected line beam Rl2 having passed the second optical path w2. Accordingly, in the reception optical system 363 of Example 3, the first optical path w1 in which the first lens 42 is provided constitute a first imaging optical system 333 and the second optical path w2 in which the second lens 43 is provided constitute a second imaging optical system 343.

In Example 3, a filter 52 is provided on the receiving surface 18 of the imaging device 17. The filter 52 has a function of preventing unintended beams from entering each reception region on the receiving surface of the imaging device. That is, in Example 3, in the receiving surface 18 of the imaging device 17, only the first reflected line beam Rl1 having passed the first optical path w1 constituting the first imaging optical system 333 enters the first region S₂₁ of the second segment S2 and only the second reflected line beam Rl2 having passed the second optical path w2 constituting the second imaging optical system 343 enters the first region S₃₁ of the third segment S3. The filter 52 is, as shown in FIG. 13, a band-pass filter configured to transmit beams having different wavelengths at upper and lower regions. The upper region 52a is configured to transmit a beam having a wavelength within a predetermined range including the wavelength of the light source 303a and prevent a beam having a wavelength other than within the predetermined range and including the wavelength of the light source 303b from being transmitted. The lower region 52b is configured to transmit a beam having a wavelength within a predetermined range including the wavelength of the light source 303b and prevent a beam having a wavelength other than within the predetermined range and including the wavelength of the light source 303a from being transmitted. The upper region 52a of the filter 52 is configured to cover at least the first region Sn of the second segment S2 on the receiving surface 18 of the imaging device 17 and the lower region 52b of the filter 52 is configured to cover at least the first region S₃₁ of the third segment S3 on the receiving surface 18 of the imaging device 17. The filter 52 is not limited thereto but may be provided in an integrated state or in a separated state if the above function is achieved.

The reception optical system 363 of Example 3 is configured as described above, and therefore a position of the reception optical system 363 in the measuring apparatus 103 is adjusted such that the reflected line beam Rl as a reflected beam from a reference position on the measurement target (wafer 16) enters or is imaged or forms an image on a reference position in the first region S₂₁ of the second segment S2 via the first optical path w1. Then, a position of the second reflecting prism 45 is adjusted (see arrow A5) such that the second reflected line beam Rl2 having passed the second optical path w2 split by the splitting prism 413 from the first optical path w1 enters or is imaged or forms an image on a reference position in the first region S₃₁ of the third segment S3. Thereby, an appropriate measurement can be achieved in the measuring apparatus 103.

In the measuring apparatus 103 employing the above described reception optical system 363, similarly to the measuring apparatus 101 of Example 1, two pieces of measurement data in which only measurable ranges (magnifications) of the object for measurement (each bump 19 in the above example) in the measurement target are different from each other can be acquired simultaneously so that it is possible to separately or simultaneously display the respective data or to combine both of the two pieces of measurement data and display the combined data on the display 14.

In the measuring apparatus 103 of Example 3, two pieces of the measurement data having different measurable ranges (magnification) in the Z direction can be acquired at one measurement operation, that is, one scanning while the resolution in the X direction being equal to each other. Therefore, substantial measurable range (magnification) can be expanded without decreasing measurement accuracy. At this time, in order to acquire two pieces of measurement data, the first reflected line beam Rl1 having passed the first optical path w1 is imaged on the first region S₂₁ of the second segment S2 on the receiving surface 18 of the imaging device 17 and the second reflected line beam Rl2 having passed the second optical path w2 is imaged on the first region S₃₁ of the segment S3 on the receiving surface 18 of the imaging device 17. Therefore, the two pieces of the measurement data can be processed simultaneously and at extremely high speed (in a minimum output processing time in the imaging device 17) so that the time required for measurement is prevented from increasing.

Furthermore, in the measuring apparatus 103 of Example 3, the line beam L irradiating the measurement target (wafer 16) mounted on the stage 12 is formed by beams emitted from the two light sources 303a, 303b having different wavelengths from each other and the filter 52 is provided the receiving surface 18 of the imaging device 17. Therefore, according to wavelength selecting function of the filter 52, only the reflected line beam Rl having passed the imaging optical system corresponding to each reception region (the first region S₂₁ of the second segment S2 and the first region S₃₁ of the third segment S3 in Example 3) in the receiving surface 18 of the imaging device 17 can be imaged on or enter the imaging device. Thereby, a plurality of pieces of measurement data (two pieces of measurement data each having a different measurable range from each other, in Example 3) according to a plurality of imaging optical systems having different optical settings for the object for measurement (each bump 19, in the above example) of the measurement target can be appropriately acquired.

Furthermore, in the measuring apparatus 103 of Example 3, as the reception optical system 363, each part (splitting prism 41, first lens 42, second lens 43, first reflecting prism 44, second reflecting prism 45, combining prism 51, and imaging device 17) is assembled. Then, the reception optical system 363 is mounted while a position of the reception optical system 363 being adjusted such that the reflected line beam Rl as a reflected beam from a reference position on the measurement target (wafer 16) is imaged on or enters a reference position on the first region S₂₁ of the second segment S2 via the first optical path w1. Then, only by adjusting a position of the second reflected prism 45, appropriate measurement can be performed.

In the measuring apparatus 103 of Example 3, two pieces of measurement data, in which only measurable ranges (magnifications) are different from each other for the object for measurement (each bump 19, in the above example) of the measurement target can be simultaneously acquired and respective measurement data may be displayed separately or simultaneously on the display 14 or may be combined so that the combined data may be displayed on the display 14. Therefore, measurement results with substantially expanded measurable range (magnification) can be understood at a glance.

Accordingly, in the measuring apparatus 103 of Example 3, the time required for measurement is not increased and a plurality of pieces of measurement data with different optical settings for the object for measurement (each bump 19) of the measurement target (wafer 16) can be acquired.

### Example 4

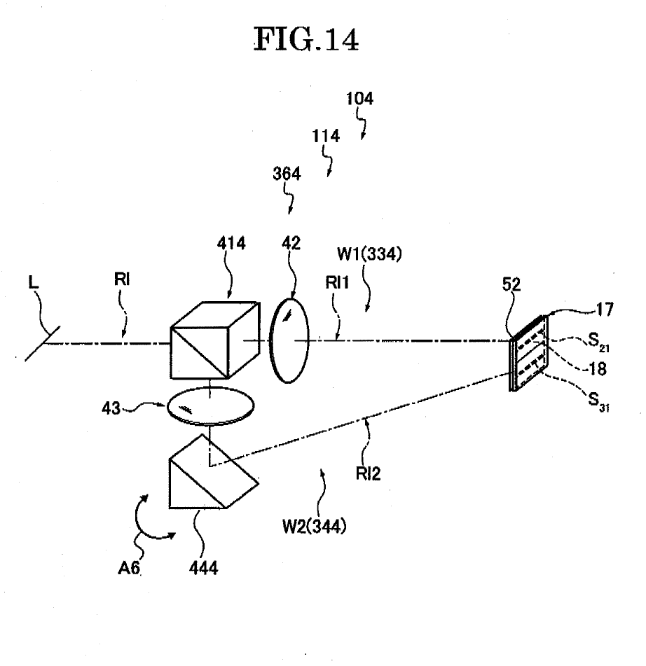

Next, a description will be given of a measuring apparatus 104 of Example 4, which is another example of a specific configuration of a reception optical system 364 in the measuring apparatus according to the present invention. Note that since basic configuration of the measuring apparatus 104 of Example 4 is the same as the measuring apparatuses 10, 102 described in the above Example 2, and 103 described in the above Example 3, parts having the same configuration are assigned the same reference numerals, and details thereof are omitted. FIG. 14 is a configuration diagram schematically showing the reception optical system 364 in an optical system 114.

The projection optical system 354 in the optical system 114 of the measuring apparatus 104 of Example 4 includes, similarly to the measuring apparatus 103 of Example 3, two light sources 303a and 303b, a wavelength combining mirror 50, and a collimating lens 31 (see FIG. 11).

The reception optical system 364 in the optical system 114 of the measuring apparatus 104 of Example 4 includes the splitting prism 414, the first lens 42, the second lens 43, the first reflecting prism 444, the filter 52 and the imaging device 17.

The splitting prism 414, similarly to the splitting prism 413 of the measuring apparatus 103 of Example 3, splits the reflected line beam Rl, which is reflected from the measurement target (wafer 16) and proceed in the Y′ direction into two optical paths, that is, the first optical path w1 on which the first reflected line beam Rl1 proceed and the second optical path w2 on which the second reflected line beam Rl2 proceeds in a direction orthogonal to the first optical path w1. The splitting prism 414 uses the wavelength separation mirror set so as to reflect a beam having the wavelength of the light source 303b while transmitting a beam having the wavelength of the light source 303a.

In the first optical path w1, the first lens 42 is provided. In the first optical path w1, the first reflected line beam Rl1 passing through the splitting prism 414 enters the receiving surface 18 (the first region S₂₁ of the second segment S2) of the imaging device 17 via the first lens 42.

In the second optical path w2, the second lens 43 and the first reflecting prism 444 are provided. In the second optical path w2, the second reflected line beam Rl2 reflected by the splitting prism 414 in the direction orthogonal to the first light path w1 proceeds to the first reflecting prism 444 via the second lens 43, and is reflected by the first reflecting prism 444 and then enters the receiving surface 18 (the first region S₃₁ of the third segment S3) of the receiving surface 18 of the imaging device 17.

In the reception optical system 364 in Example 4, similarly to the reception optical system 361 of Example 1, only the measurable ranges (magnification) for the object for measurement (each bump 19, in the above example) of the measurement target are different from each other in the first reflected line beam Rl1 having passed the first optical path w1 and the second reflected line beam Rl2 having passed the second optical path w2. Accordingly, in the reception optical system 364 of Example 4, the first optical path w1 in which the first lens 42 is provided constitutes a first imaging optical system 334 and the second optical path w2 in which the second lens 43 is provided constitutes a second imaging optical system 344.

In the reception optical system 364 of Example 4, similarly to the reception optical system 363 of Example 3, a filter 52 is provided on the receiving surface 18 of the imaging device 17. The filter 52 has a function of preventing unintended beams from entering each reception region on the receiving surface of the imaging device. That is, in Example 4, in the receiving surface 18 of the imaging device 17, only the first reflected line beam Rl1 having passed the first optical path w1 constituting the first imaging optical system 334 enters the first region S₂₁ of the second segment S2 and only the second reflected line beam Rl2 having passed the second optical path w2 constituting the second imaging optical system 344 enters the first region S₃₁ of the third segment S3.

The reception optical system 364 of Example 4 is configured as described above, and therefore easy setting and adjusting when mounting the reception optical system 364 on the measuring apparatus 104 can be achieved. This will be explained below. Firstly, the reception optical system 364 is formed by assembling each part as described above. Then, in the measuring apparatus 104, a position of the reception optical system 364 is adjusted such that the reflected line beam Rl as a reflected beam from a reference position on the wafer 16 mounted on the stage 12 enters or is imaged or forms an image on a reference position in the first region S₂₃ of the second segment S2 via the first optical path w1. Then, a rotating state of the first reflecting prism 444 is adjusted (see arrow A6) such that the second reflected line beam Rig having passed the second optical path w2 split by the splitting prism 414 from the first optical path w1 enters or is imaged or forms an image on a reference position in the first region S81 of the third segment S3. In the adjustment according to the rotating state of the first reflecting prism 444, an imaging position or an entering position of the second reflected line beam Rl2 having passed the second optical path w2 can be adjusted by rotating the first reflecting prism 444 about the X′ direction. If this adjustment is performed when producing the measuring apparatus 104 is performed, appropriate measurement can be achieved.

In the measuring apparatus 104 of Example 4 employing the above described reception optical system 364, similarly to the measuring apparatus 101 of Example 1, two pieces of measurement data in which only measurable ranges (magnifications) of the object for measurement (each bump 19 in the above example) in the measurement target are different from each other can be acquired simultaneously so that it is possible to separately or simultaneously display the respective data on the display 14 or to combine both of the two pieces of measurement data and display the combined data on the display 14.

In the measuring apparatus 104 of Example 4, two pieces of the measurement data having different measurable ranges (magnifications) in the Z direction can be acquired at one measurement operation, that is, one scanning while the resolution in the X direction being equal to each other. Therefore, substantial measurable range (magnification) can be expanded without decreasing measurement accuracy. At this time, in order to acquire two pieces of measurement data, the first reflected line beam Ell having passed the first optical path w1 is imaged on the first region S₂₁ of the second segment S2 on the receiving surface 18 of the imaging device 17 and the second reflected line beam Rl2 having passed the second optical path w2 is imaged on the first region S₃₁ of the segment S3 on the receiving surface 18 of the imaging device 17. Therefore, the two pieces of the measurement data can be processed simultaneously and at extremely high speed (in a minimum output processing time in the imaging device 17) so that the time required for measurement is prevented from increasing.

Furthermore, in the measuring apparatus 104 of Example 4, the line beam L irradiating the measurement target (wafer 16) mounted on the stage 12 is formed by beams emitted from the two light sources 303a, 303b having different wavelengths from each other and the filter 52 is provided the receiving surface 18 of the imaging device 17. Therefore, according to wavelength selecting function of the filter 52, only the reflected line beam Rl having passed the imaging optical system corresponding to each reception region (the first region S₂₁ of the second segment S2 and the first region S₃₁ of the third segment S3 in Example 3) in the receiving surface 18 of the imaging device 17 can be imaged on or enter the imaging device. Thereby, a plurality of pieces of measurement data (two pieces of measurement data each having a different measurable range from each other, in Example 3) according to a plurality of imaging optical systems having different optical settings for the object for measurement (each bump 19, in the above example) of the measurement target can be appropriately acquired.

Furthermore, in the measuring apparatus 104 of Example 4, as the reception optical system 364, each part (splitting prism 414, first lens 42, second lens 43, first reflecting prism 444, light shielding part 49, and imaging device 17) is assembled. Then, the reception optical system 364 is mounted while a position of the reception optical system 364 being adjusted such that the reflected line beam Rl as a reflected beam from a reference position on the measurement target (wafer 16) is imaged on or enters a reference position on the first region S₂₁ of the second segment S2 via the first optical path w1. Then, only by adjusting a rotating state of the first reflected prism 444, appropriate measurement can be performed.

In the measuring apparatus 104 of Example 4, two pieces of measurement data, in which only measurable ranges (magnifications) are different from each other for the object for measurement (each bump 19, in the above example) of the measurement target can be simultaneously acquired and respective measurement data may be displayed separately or simultaneously on the display 14 or may be combined so that the combined data may be displayed on the display 14. Therefore, measurement results with substantially expanded measurable range (magnification) can be understood at a glance.

Accordingly, in the measuring apparatus 104 of Example 4, the time required for measurement is not increased and a plurality of pieces of measurement data with different optical settings for the object for measurement (each bump 19) of the measurement target (wafer 16) can be acquired.

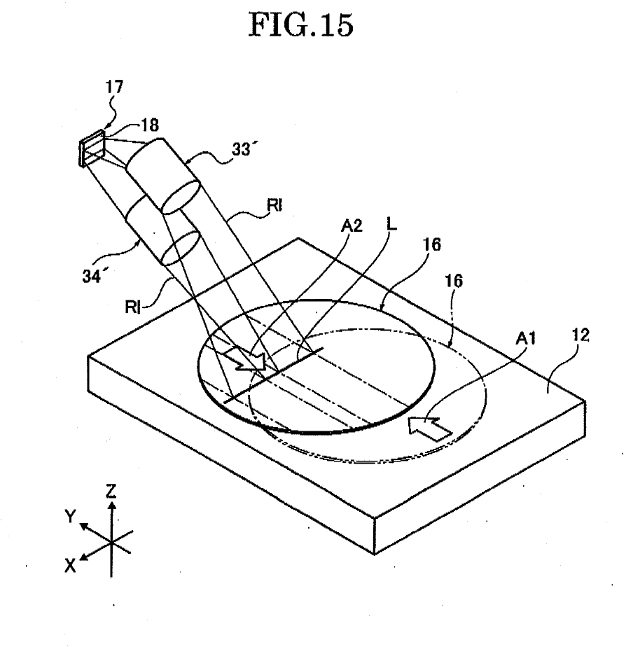

In each of the above examples, as difference in optical settings for the object for measurement of the measurement target in each imaging optical system provided according to each reception region in the receiving surface of the imaging device, a case of difference in the measurable range (magnification) for the object for measurement of the measurement target is described as an example, but the difference is not limited thereto. For example, difference in optical settings for the object for measurement of the measurement target in each imaging optical system may be difference in resolution for the measurement target. The resolution for the measurement target is, as described above, range to be measured in a dimension in the X direction on the measurement target mounted on the stage 12. Accordingly, as shown in FIG. 15, the measurement result (measurement data) from wide measurement range can be acquired by using the first imaging optical system 33′ having low resolution so that number of scanning operations for the measurement target (wafer 16) can be decreased and the measurement result with high accuracy can be acquired by using the second imaging optical system 34′ having high resolution. The above described first imaging optical system 33′ and second imaging optical system 34′ may be configured such that expansion/reduction in the X direction on the measurement target (wafer 16) mounted on the stage 12, that is, for example, a cylindrical lens may be used. FIG. 15 is an explanatory view showing difference in resolution for the measurement target to be easily understood. Actually, the reflected line beam Rl from the measurement target (wafer 16) is guided to the first imaging optical system 33′ and the second imaging optical system 34′ via the optical splitting mechanism (see reference number 82 in FIGS. 2 and 11).

Moreover, as difference in optical settings for the object for measurement of the measurement target in each imaging optical system, arbitrary combination of a measurable range (magnification) for the object for measurement in the measurement target and resolution for the measurement target may be used. In this case, each imaging optical system arbitrarily combines magnifications in two directions (the X direction and the Z direction) on the measurement target (wafer 16) mounted on the stage 12. Accordingly, two cylindrical lenses may be used or toroidal surface and aspheric surface lenses may be used. Furthermore, if the magnifications in two directions are set to be equal to each other, common lenses may be used.

Although in the above described Examples 1, 2, the line beam is formed by beams having a single wavelength and in the above described Examples 3, 4, the line beam is formed by beams having a plurality of wavelengths, the above Examples may be combined. In this case, for example, a line beam may be formed by beams having two wavelengths for four imaging optical systems. That is, the reflected line beam is split into two beams by the wavelength separation mirror, and then, each of two beams is split by a half mirror so that individual reflected line beams are guided to the imaging optical systems, respectively. At this time, in the imaging device, it is preferable to prevent beams other than the corresponding reflected line beam from proceeding to the corresponding reception region in the receiving surface by appropriately combining a light shielding part or an optical guiding device and a filter.

Then, in each of the above examples, by adjusting a position of the second reflecting prism 45 or by adjusting a rotating state of the first reflecting prism 44 (444), appropriate measurement can be achieved. However, it is only required that the configuration in which the adjustment for allowing an appropriate measurement can be performed is provided. That is, for example, in the reception optical system (36 and the like) having the above describe configuration, a pair of wedge prisms (not illustrated) may be provided in each of the first optical path w1 and the second optical path w2 and it is not limited to the above describe Examples.

Although the present invention has been described in terms of exemplary embodiments, it is not limited thereto. It should be appreciated that variations may be made in the embodiments described by persons skilled in the art without departing from the scope of the present invention as defined by the following claims.

### EFFECT OF THE INVENTION

According to a measuring apparatus of an embodiment of the present invention, only by one measuring operation, that is, one scanning, a plurality of pieces of measurement data according to number of a plurality of imaging optical systems can be acquired. At this time, in order to acquire the plurality of pieces of the measurement data, each reflected line beam having passed each imaging optical system is configured to be imaged on a different reception region from each other in the receiving surface of the imaging device. Accordingly, the plurality of pieces of measurement data can be processed simultaneously and at high speed in the imaging device so that time required for measurement can be prevented from increasing.

In a case where the reception region is a region for which output processing is firstly performed in each of the segments on the receiving surface of the imaging device, in the imaging device, a plurality of pieces of measurement data can be processed simultaneously and at an extremely high speed so that time required for measurement can be effectively prevented from increasing.

In a case where the optical setting for the object for measurement in the measurement target in each of the plurality of optical imaging systems is a measurable range in a height direction in the measurement target, a plurality of pieces of measurement data each having a measurable range in a height direction in the measurement target can be acquired at one measurement operation, that is, one scanning. Therefore, substantially measurable range, that is magnification in the height direction can be expanded without decreasing measurement accuracy.

In a case where the optical setting for the object for measurement in the measurement target in each of the plurality of optical imaging systems is a range to be measured in an extending direction of the line beam on the measurement target, a plurality of pieces of measurement data each having a different measurable range in the extending direction of the line beam on the measurement target can be acquired at one measurement operation, that is, one scanning. Therefore, the measurement range, that is, resolution in the extending direction of the line beam can be expanded. As a result, number of scanning processings for the measurement target can be decreased so that inspection speed (through put) at a whole can be improved.

In a case where the optical setting for the object for measurement in the measurement target in each of the plurality of optical imaging systems is a combination of a measurable range in a height direction on the measurement target and a range to be measured in an extending direction of the line beam in the measurement target, a plurality of pieces of measurement data which are different from each other in an arbitrary combination of a measurable range in the height direction and a measurement range in the extending direction of the line beam can be acquired at one measurement operation, that is, one scanning. Therefore, degree of freedom of the corresponding measurement target can be enhanced.

In a case where the projection optical system forms the line beam having a single wavelength and the beam splitting mechanism splits the reflected line beam having the single wavelength according to a number of the plurality of optical imaging systems, configuration of a single light source is used so that a simple configuration can be achieved.

In a case where the projection optical system forms the line beam including a plurality of beams having wavelengths different from each other and the beam splitting mechanism splits the reflected line beam including the plurality of beams having the wavelengths different from each other according to a number of the plurality of optical imaging systems, each piece of measurement data is acquired based on the reflected line beam including beams each having a different wavelength from each other, and therefore, measurement accuracy of each piece of measurement data can be enhanced with increasing light transmission efficiency.

In a case where the measuring apparatus includes an entering beam controlling mechanism provided between the optical imaging system and the imaging device, and configured to cause only the reflected line beam from the optical imaging system corresponding to each of the reception regions to enter the imaging device, the measurement data according to each imaging optical system, that is, having different optical settings can be appropriately acquired.

In a case where the projection optical system forms the line beam having a single wavelength and the entering beam controlling mechanism is a light shielding member configured to partition the receiving surface according to each of the reception regions, reliability of each measurement data can be enhanced by a simple configuration.

In a case where the projection optical system forms the line beam having a single wavelength and the entering beam controlling mechanism is a guiding device configured to guide beams to the reception regions, respectively, reliability of each measurement data can be enhanced by a simple configuration.

In a case where the projection optical system forms the line beam including a plurality of beams having different wavelengths from each other and the entering beam controlling mechanism is a filter configured to transmit only beams within a predetermined wavelength range of the plurality of beams having different wavelengths from each other, reliability of each measurement data can be enhanced by a further simple configuration.

In a case where a measuring apparatus includes a projection optical system configured to radiate a line beam on a measurement target and a reception optical system including an imaging device configured to acquire a reflected line beam reflected from the measurement target, the measuring apparatus measuring a surface shape of the measurement target on the basis of a geometric positional relationship in the reflected line beam on the measurement target, the reflected line beam being acquired by the imaging device, the imaging device has a receiving surface in which a plurality of segments are set, and the reception optical system splits the reflected line beam and causes the split reflected line beams to form images on the different segments in the receiving surface of the imaging device so as to acquire a shape of the line beam on the measurement target, a plurality of pieces of measurement information (measurement data) can be acquired simultaneously without increasing time required for measurement.

What is claimed is:

1. A measuring apparatus comprising:
a projection optical system configured to radiate a line beam on a measurement target; and
an imaging device configured to acquire a reflected line beam reflected from the measurement target, the measuring apparatus measuring a surface shape of the measurement target on the basis of a geometric positional relationship in the reflected line beam on the measurement target, the reflected line beam being acquired by the imaging device; the measuring apparatus further comprising
a plurality of optical imaging systems each provided between the measurement target and the imaging device, and each configured to cause the reflected line beam to form an image on a receiving surface of the imaging device so that a shape of the line beam on the measurement target is acquired; and
a beam splitting mechanism provided between the measurement target and each of the plurality of optical imaging systems, and configured to split the reflected line beam and guide the split reflected line beam to the imaging device, wherein
the optical imaging systems have different optical settings for the object in the measurement target from each other;
a plurality of segments are set on the receiving surface of the imaging device while each of the segments is partitioned into a plurality of regions, and at least one region in each of the segments is set as a reception region; and
the optical imaging system causes the reflected line beams split by the beam splitting mechanism to form images on the reception regions in the different segments, respectively, on the receiving surface of the imaging device.

2. The measuring apparatus according to claim 1, wherein the reception region is a region for which output processing is firstly performed in each of the segments on the receiving surface of the imaging device.

3. The measuring apparatus according to claim 1, wherein the optical setting for the object for measurement in the measurement target in each of the plurality of optical imaging systems is a measurable range in a height direction in the measurement target.

4. The measuring apparatus according to claim 2, wherein the optical setting for the object for measurement in the measurement target in each of the plurality of optical imaging systems is a measurable range in a height direction in the measurement target.

5. The measuring apparatus according to claim 1, wherein the optical setting for the object for measurement in the measurement target in each of the plurality of optical imaging systems is a range to be measured in an extending direction of the line beam on the measurement target.

6. The measuring apparatus according to claim 2, wherein the optical setting for the object for measurement in the measurement target in each of the plurality of optical imaging systems is a range to be measured in an extending direction of the line beam on the measurement target.

7. The measuring apparatus according to claim 1, wherein the optical setting for the object for measurement in the measurement target in each of the plurality of optical imaging systems is a combination of a measurable range in a height direction on the measurement target and a range to be measured in an extending direction of the line beam in the measurement target.

8. The measuring apparatus according to claim 2, wherein the optical setting for the object for measurement in the measurement target in each of the plurality of optical imaging systems is a combination of a measurable range in a height direction on the measurement target and a range to be measured in an extending direction of the line beam in the measurement target.

9. The measuring apparatus according to claim 1, wherein the projection optical system forms the line beam having a single wavelength; and
the beam splitting mechanism splits the reflected line beam having the single wavelength according to a number of the plurality of optical imaging systems.

10. The measuring apparatus according to claim 1, wherein the projection optical system forms the line beam including a plurality of beams having wavelengths different from each other; and
the beam splitting mechanism splits the reflected line beam including the plurality of beams having the wavelengths different from each other according to a number of the plurality of optical imaging systems.

11. The measuring apparatus according to claim 1, further comprising:
an entering beam controlling mechanism provided between the optical imaging system and the imaging device, and configured to cause only the reflected line beam from the optical imaging system corresponding to each of the reception regions to enter the imaging device.

12. The measuring apparatus according to claim 11, wherein the projection optical system forms the line beam having a single wavelength; and
the entering beam controlling mechanism is a light shielding member configured to partition the receiving surface according to each of the reception regions.

13. The measuring apparatus according to claim 11, wherein the projection optical system forms the line beam having a single wavelength; and
the entering beam controlling mechanism is a guiding device configured to guide beams to the reception regions, respectively.

14. The measuring apparatus according to claim 11, wherein the projection optical system forms the line beam including a plurality of beams having different wavelengths from each other; and
the entering beam controlling mechanism is a filter configured to transmit only beams within a predetermined wavelength range of the plurality of beams having different wavelengths from each other.

15. A measuring apparatus comprising:
a projection optical system configured to radiate a line beam on a measurement target; and
a reception optical system including an imaging device configured to acquire a reflected line beam reflected from the measurement target, the measuring apparatus measuring a surface shape of the measurement target on the basis of a geometric positional relationship in the reflected line beam on the measurement target, the reflected line beam being acquired by the imaging device, wherein
the imaging device has a receiving surface in which a plurality of segments are set; and
the reception optical system splits the reflected line beam and causes the split reflected line beams to form images on the different segments in the receiving surface of the imaging device so as to acquire a shape of the line beam on the measurement target.
